(19) United States
(12) Patent Application Publication
(10) Pub. No.: US 2023/0259746 A1
(43) Pub. Date: Aug. 17, 2023

(54) DEVICE FOR FORWARD FUSION OF NEURAL NETWORK, BOARD, METHOD, AND READABLE STORAGE MEDIUM

(71) Applicant: Cambricon Technologies Corporation Limited, Beijing (CN)

(72) Inventors: Huiying LAN, Beijing (CN); Ruitao WANG, Beijing (CN); Haizhao LUO, Beijing (CN); Bo CAO, Beijing (CN); Xunyu CHEN, Beijing (CN)

(21) Appl. No.: 18/003,678

(22) PCT Filed: Sep. 24, 2021
(86) PCT No.: PCT/CN2021/120231

§ 371 Date: Dec. 28, 2022

(30) Foreign Application Priority Data
Sep. 28, 2020 (CN) 202011043888.9
Sep. 28, 2020 (CN) 202011043897.8
Sep. 28, 2020 (CN) 202011043900.6
Sep. 28, 2020 (CN) 202011043902.5
Sep. 28, 2020 (CN) 202011043905.9
Sep. 28, 2020 (CN) 202011045858.1

(51) Int. Cl. G06N 3/063; G06N 3/04

(52) U.S. Cl. CPC G06N 3/063; G06N 3/04

(57) ABSTRACT

The present disclosure relates to an apparatus and a method for forward fusing a neural network, a board card, and a readable storage medium. The computing apparatus of the present disclosure is included in an integrated circuit apparatus. The integrated circuit apparatus includes a general interconnection interface and other processing apparatus. The computing apparatus interacts with other processing apparatus to jointly complete a computing operation specified by a user. The integrated circuit apparatus further includes a storage apparatus. The storage apparatus is connected to the computing apparatus and other processing apparatus, respectively. The storage apparatus is used for data storage of the computing apparatus and other processing apparatus.

### CROSS REFERENCE OF RELATED APPLICATIONS

The present application claims priority to: Chinese Patent Application No. 2020110438889 with the title of “Apparatus and Method for Fusion of Neural Network, Board Card, and Readable Storage Medium” filed on Sep. 28, 2020; Chinese Patent Application No. 2020110439006 with the title of “Apparatus and Method for Forward Fusion of Neural Network, Board Card, and Readable Storage Medium” filed on Sep. 28, 2020; Chinese Patent Application No. 2020110439025 with the title of “Apparatus and Method for Fusion of Neural Network, Board Card, and Readable Storage Medium” filed on Sep. 28, 2020; Chinese Patent Application No. 2020110439059 with the title of “Apparatus and Method for Fusion of Network Based on Feature Map, Board Card, and Readable Storage Medium” filed on Sep. 28, 2020; Chinese Patent Application No. 2020110458581 with the title of “Apparatus and Method for Fusion of Network Based on Feature Map, Board Card, and Readable Storage Medium” filed on Sep. 28, 2020; and Chinese Patent Application No. 2020110438978 with the title of “Apparatus and Method for Dynamic Fusion of Neural Network, Board Card, and Readable Storage Medium” filed on Sep. 28, 2020. The contents of the aforementioned applications are incorporated herein by reference in their entireties.

### TECHNICAL FIELD

The present disclosure generally relates to a neural network field. More specifically, the present disclosure relates to an apparatus and a method for forward fusing a neural network, a board card, and a readable storage medium.

### BACKGROUND

A neural network is composed of a plurality of neuron systems connected according to certain rules. Roughly, the neural network is composed of following four kinds of layers: an input layer, a convolution layer, a pooling layer, and a fully connected layer.

The input layer is configured to truncate part of information from input data and convert the part of information into a feature matrix for presentation, where the feature matrix contains features corresponding to the part of information. The convolution layer is configured to receive the feature matrix from the input layer and perform feature extraction on the input data through a convolution operation. The convolution layer may be a multi-layer convolution layer in practice. The pooling layer is configured to replace a certain area of data with a value. The value is usually a maximum value or an average value of all values in the area. By pooling, on the premise of not losing too much information, a size of a model may be reduced, and computing speed may be improved. The fully connected layer plays the role of a classifier in the whole convolution neural network, which is equivalent to feature space conversion. In the fully connected layer, all useful information in previous layers may be extracted and integrated, and the information may be compared based on different categories to judge whether the input data is similar to objects for comparison.

With the development of technology, the number of layers of the neural network is increasing. Taking a classical visual geometry group (VGG) architecture as an example, VGG-A has a total of 11 weight layers, VGG-B has a total of 13 weight layers, VGG-C has a total of 16 weight layers, VGG-D has a total of 16 weight layers, and VGG-E has a total of 19 weight layers. The convolution layer and the fully connected layer refer to the weight layer in general. Some neural networks even have hundreds of layers. Not only that, with the increase of the number of layers, the number of parameters of the neural network also increases exponentially. For example, AlexNet has 60 million parameters participating in computing.

Both multiple layers and multiple parameters require a lot of on-chip and off-chip input/output accesses, which consume a lot of resources and delay operation time simultaneously. Therefore, a mechanism to reduce input/output accesses is urgently required in the field of artificial intelligence.

### SUMMARY

In order to at least partly solve technical problems mentioned in BACKGROUND, a solution of the present disclosure provides an apparatus and a method for forward fusing a neural network, a board card, and a readable storage medium.

A first aspect of the present disclosure discloses an integrated circuit apparatus for forward fusing a neural network, which includes a processing apparatus and a computing apparatus. The processing apparatus is configured to perform a fusion in a direction of a starting point of the neural network to create a template fuse unit. The computing apparatus is configured to perform neural network computing according to the template fuse unit.

A second aspect of the present disclosure discloses a board card, including the integrated circuit apparatus.

A third aspect of the present disclosure discloses a method for forward fusing a neural network, including: performing a fusion in a direction of a starting point of the neural network to create a template fuse unit; and performing neural network computing according to the template fuse unit.

A fourth aspect of the present disclosure discloses a computer readable storage medium, on which computer program codes for forward fusing a neural network are stored. When the computer program codes are run by a processing apparatus, the method is performed.

The present disclosure relates to a forward fusion solution and flexibly provides more fusion methods to adapt to different neural network models and reduce input/output overheads.

### BRIEF DESCRIPTION OF DRAWINGS

By reading the following detailed description with reference to drawings, the above and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 is a structural diagram of a board card according to an embodiment of the present disclosure.

FIG. 2 is a structural diagram of an integrated circuit apparatus according to an embodiment of the present disclosure.

FIG. 3 is a schematic diagram of an internal structure of a computing apparatus according to an embodiment of the present disclosure.

FIG. 4 is a schematic diagram of an internal structure of a processor core according to an embodiment of the present disclosure.

FIG. 5 is a schematic diagram that a processor core intends to write data to a processor core of another cluster.

FIG. 6 is a schematic diagram of an AlexNet model.

FIG. 7 is a schematic diagram of an exemplary neural network model.

FIG. 8 is a schematic diagram that two convolution layers are fused together according to an embodiment of the present disclosure.

FIG. 9 is a diagram of formats of NCHW and NHWC.

FIG. 10 is a flowchart of performing neural network computing by using a template fuse unit according to an embodiment of the present disclosure.

FIG. 11 is a flowchart of dynamically fusing a neural network according to a fusion policy according to an embodiment of the present disclosure.

FIG. 12 is a flowchart of performing neural network computing by using a template fuse unit according to an embodiment of the present disclosure.

FIG. 13 is a schematic diagram of a neural network model with a block structure.

FIG. 14 is a flowchart of computing a neural network based on an executable instruction according to an embodiment of the present disclosure.

FIG. 15 shows an exemplary long-chain neural network.

FIG. 16 is a flowchart of implementing a forward fusion of a neural network according to an embodiment of the present disclosure.

FIG. 17 is an exemplary long-chain neural network.

FIG. 18 is a flowchart of implementing a bidirectional fusion of a neural network according to an embodiment of the present disclosure.

FIG. 19 shows an exemplary block-structured neural network.

### DETAILED DESCRIPTION

Technical solutions in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” that appear in the claims, the specification, and the drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that terms used in the specification of the present disclosure are merely intended to describe a specific embodiment rather than to limit the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context.

Specific implementations of the present disclosure will be described in detail in combination with drawings below.

A neural network is composed of an input layer, a convolution layer, an activation function, a pooling layer, and a fully connected layer, with several layers at least and hundreds of layers at most. Each layer performs an operator. For example, the convolution layer performs a convolution operator, and how many operators are required to be performed as there are how many layers. When a particular layer is mentioned in the present disclosure, the layer refers to an operator corresponding to the layer.

During neural network computing, input information and an output result of each layer of a model are different for each inference computing and are viewed as variable data. The variable data is generally represented by a feature map (matrix). In the present disclosure, input information of the whole neural network model and an input map of each layer of the model are collectively called a feature map. Once the feature map is loaded onto an on-chip memory component, the feature map is referred as an on-chip unit map in the present disclosure. Parameters for training a network model usually do not change frequently after the training is stabilized, or the parameters are compiled and generated after a network topology structure and hardware parameters are determined and do not change in a computing process. Therefore, the parameters may be viewed as constant data. The constant data includes but is not limited to a weight, a bias, a device hardware instruction, a mean and a variance of batchnorm, and the like. In the present disclosure, the weight is used to represent all constant data uniformly. However, when “data” is mentioned in the present disclosure, the “data” generally refers to a map structure that allows operations corresponding to operators to be fused together in the neural network model according to a fusion policy. Variable data and constant data involved in the map structure are feature maps plus corresponding weights.

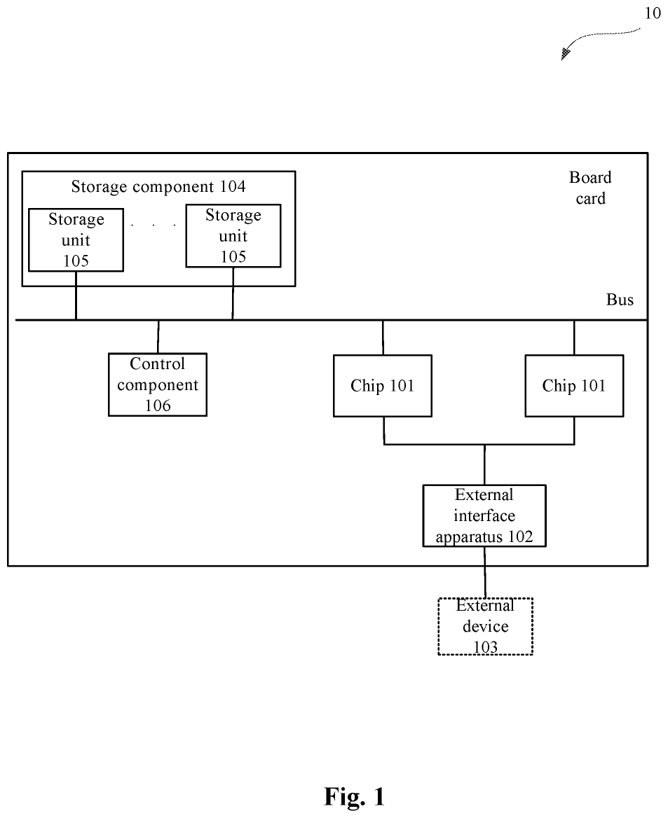

FIG. 1 is a schematic structural diagram of a board card 10 according to an embodiment of the present disclosure. As shown in FIG. 1, the board card 10 includes a chip 101, which is a system on chip (SoC), or called an on-chip system, and integrates one or a plurality of combined processing apparatuses. The combined processing apparatus is an artificial intelligence operation unit, which is used to support various deep learning algorithms and various machine learning algorithms and meet requirements for intelligent processing in complex scenarios in computer vision, speech, natural language processing, data mining, and other fields. In particular, deep learning technology is widely applied in the field of cloud intelligence. A notable feature of cloud intelligence applications is a large amount of input data, which has high requirements for storage capacity and computing power of a platform. The board card 10 of this embodiment is suitable for cloud intelligent applications. The board card 10 of this embodiment has huge off-chip storage, huge on-chip storage, and a lot of computing power.

The chip 101 is connected to an external device 103 through an external interface apparatus 102. The external device 103 may be, for example, a server, a computer, a camera, a monitor, a mouse, a keyboard, a network card, or a WIFI interface. To-be-processed data may be transferred from the external device 103 to the chip 101 through the external interface apparatus 102. A computing result of the chip 101 is still sent back to the external device 103 by the external interface apparatus 102. According to different application scenarios, the external interface apparatus 102 may have different interface forms, such as a peripheral component interconnect express (PCIe) interface.

The board card 10 further includes a storage component 104 used for storing data. The storage component 104 includes one or a plurality of storage units 105. The storage component 104 is connected to and transfers data to a control component 106 and the chip 101 through a bus. The control component 106 in the board card 10 is configured to regulate and control a state of the chip 101. As such, in an application scenario, the control component 106 may include a micro controller unit (MCU).

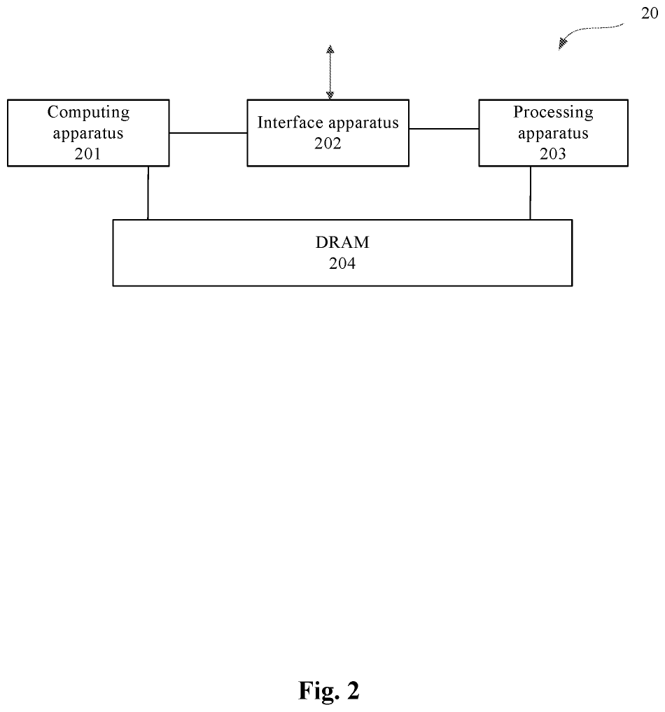

FIG. 2 is a structural diagram of a combined processing apparatus in the chip 101 of this embodiment. As shown in FIG. 2, the combined processing apparatus 20 includes a computing apparatus 201, an interface apparatus 202, a processing apparatus 203, and a dynamic random access memory (DRAM) 204.

The computing apparatus 201 is configured to perform an operation specified by a user. The computing apparatus 201 is mainly implemented as a single-core intelligent processor or a multi-core intelligent processor. The computing apparatus 201 is used for performing deep learning computing or machine learning computing. The computing apparatus 201 interacts with the processing apparatus 203 through the interface apparatus 202 to jointly complete the operation specified by the user.

The interface apparatus 202 is used to transfer data and control instructions between the computing apparatus 201 and the processing apparatus 203. For example, the computing apparatus 201 may acquire input data from the processing apparatus 203 via the interface apparatus 202 and write the input data to an on-chip storage apparatus of the computing apparatus 201. Further, the computing apparatus 201 may acquire the control instructions from the processing apparatus 203 via the interface apparatus 202 and write the control instructions to an on-chip control cache of the computing apparatus 201. Alternatively or optionally, the interface apparatus 202 may further read data in the storage apparatus of the computing apparatus 201 and then transfer the data to the processing apparatus 203.

The processing apparatus 203 serves as a general processing apparatus and performs basic controls that include but are not limited to moving data, starting and/or stopping the computing apparatus 201. According to different implementations, the processing apparatus 203 may be a central processing unit (CPU), a graphics processing unit (GPU), or one or more types of other general and/or dedicated processors. These processors include but are not limited to a digital signal processor (DSP), an application specific integrated circuit (ASIC), a field-programmable gate array (FPGA), or other programmable logic components, discrete gate or transistor logic components, discrete hardware components, and the like. Moreover, the number of the processors may be determined according to actual requirements. As described above, with respect to the computing apparatus 201 of the present disclosure only, the computing apparatus 201 of the present disclosure may be viewed as having a single-core structure or an isomorphic multi-core structure. However, when the computing apparatus 201 and the processing apparatus 203 are considered together, both the computing apparatus 201 and the processing apparatus 203 may be viewed as forming a heterogeneous multi-core structure.

The DRAM 204 is used for storing to-be-processed data. The DRAM 204 is a double data rate (DDR) memory with a size of 16G or more than 16G generally. The DRAM 204 is used for saving data of the computing apparatus 201 and/or the processing apparatus 203.

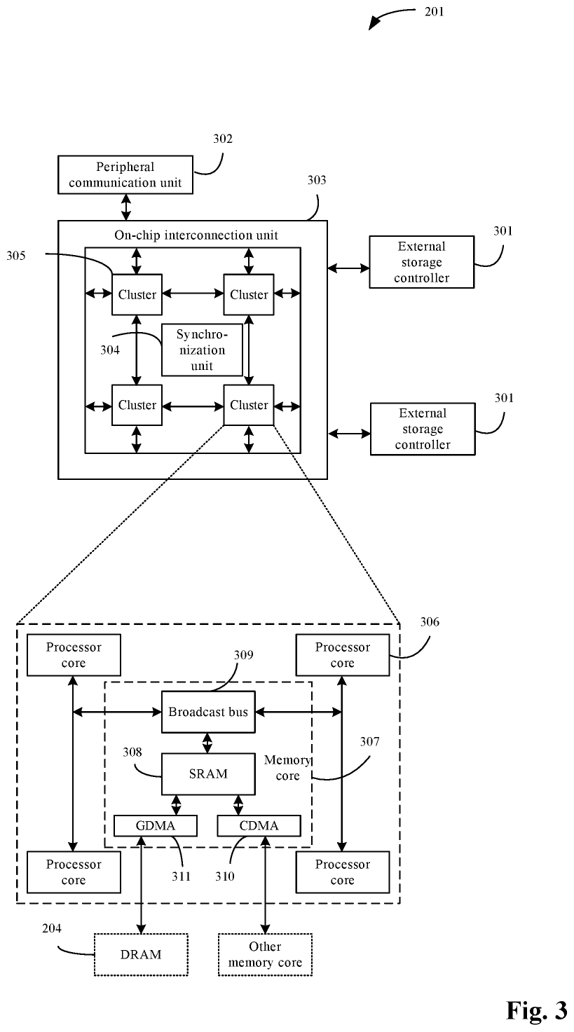

FIG. 3 is a schematic diagram of an internal structure of the computing apparatus 201. The computing apparatus 201 is used for processing input data in computer vision, speech, natural language, and data mining. The computing apparatus 201 in the figure is designed in a multi-core hierarchical structure. The computing apparatus 201 serves as an on-chip system, which includes a plurality of clusters. Each cluster further includes a plurality of processor cores. In other words, the computing apparatus 201 is composed of SoC-cluster-processor core hierarchy.

In terms of a hierarchy of the on-chip system, as shown in FIG. 3, the computing apparatus 201 includes an external storage controller 301, a peripheral communication unit 302, an on-chip interconnection unit 303, a synchronization unit 304, and a plurality of clusters 305.

There may be a plurality of external storage controllers 301, two of which are illustrated in the figure. The external storage controllers are used to, in response to access requests from the processor cores, access an external storage device, such as the DRAM 204 in FIG. 2, thereby reading data from off-chip or writing the data to off-chip. The peripheral communication unit 302 is used to receive a control signal from the processing apparatus 203 through the interface apparatus 202 and start the computing apparatus 201 to perform a task. The on-chip interconnection unit 303 connects the external storage controller 301, the peripheral communication unit 302, and the plurality of clusters 305. The on-chip interconnection unit 303 is used for transferring data and control signals between units. The synchronization unit 304 is a global barrier controller (GBC). The synchronization unit 304 is used for coordinating a work progress of each cluster, so as to ensure synchronization of information. The plurality of clusters 305 are computing cores of the computing apparatus 201, four of which are illustrated in the figure. With the development of hardware, the computing apparatus 201 of the present disclosure may further include 8, 16, 64, or even more clusters 305. The clusters 305 are used for efficiently performing deep learning algorithms.

In terms of a hierarchy of the clusters, as shown in FIG. 3, each cluster 305 includes a plurality of processor cores (IPU cores) 306 and a memory core (MEM core) 307.

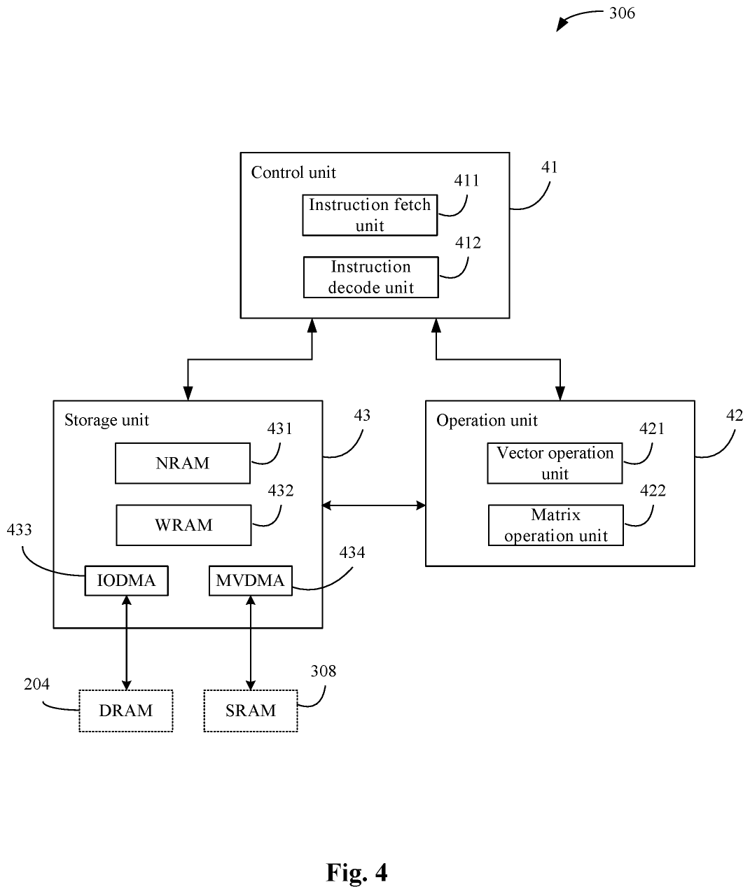

Four processor cores 306 are illustrated in the figure. The present disclosure does not limit the number of the processor cores 306. An internal structure of a processor core is as shown in FIG. 4. Each processor core 306 includes three units: a control unit 41, an operation unit 42, and a storage unit 43.

The control unit 41 is used for coordinating and controlling work of the operation unit 42 and the storage unit 43, so as to complete a deep learning task. The control unit 41 includes an instruction fetch unit (IFU) 411 and an instruction decode unit (IDU) 412. The instruction fetch unit 411 is used for acquiring an instruction from the processing apparatus 203. The instruction decode unit 412 is used for decoding the instruction acquired and sending a decoding result as control information to the operation unit 42 and the storage unit 43.

The operation unit 42 includes a vector operation unit 421 and a matrix operation unit 422. The vector operation unit 421 is used for performing a vector operation and supports complex operations, such as vector multiplication, vector addition, and vector nonlinear conversion. The matrix operation unit 422 is responsible for core computing of deep learning algorithms, which includes matrix multiplication and matrix convolution.

The storage unit 43 is used for storing or moving related data. The storage unit 43 includes a neuron storage unit (neuron RAM, NRAM) 431, a weight storage unit (weight RAM, WRAM) 432, an input/output direct memory access unit (input/output direct memory access, IODMA) 433, and a move direct memory access unit (move direct memory access, MVDMA) 434. The NRAM 431 is used for storing a feature map for computing by the processor cores 306 and an intermediate result after the computing. The WRAM 432 is used for storing a weight of a deep learning network. The IODMA 433 controls memory access of the NRAM 431/the WRAM 432 and the DRAM 204 through a broadcast bus 309. The MVDMA 434 is used for controlling memory access of the NRAM 431/the WRAM 432 and a shared storage unit (shared RAM, SRAM) 308.

Going back to FIG. 3, the memory core 307 is mainly used for storage and communication. In other words, the memory core 307 is mainly used for storing shared data or intermediate results between the processor cores 306 and performing communication between the clusters 305 and the DRAM 204, communication between the clusters 305, and communication between the processor cores 306. In other embodiments, the memory core 307 is able to perform a scalar operation. The memory core 307 is used for performing the scalar operation.

The memory core 307 includes the SRAM 308, the broadcast bus 309, a cluster direct memory access unit (cluster direct memory access, CDMA) 310, and a global direct memory access unit (global direct memory access, GDMA) 311. The SRAM 308 plays the role of a high-performance data transfer station. Data reused among different processor cores 306 in the same cluster 305 is not required to be acquired from the DRAM 204 separately through the processor cores 306. Instead, the data is transferred among the processor cores 306 through the SRAM 308. The memory core 307 is only required to quickly distribute the reused data from the SRAM 308 to the plurality of processor cores 306, so as to improve inter-core communication efficiency and greatly reduce on-chip/off-chip input/output accesses.

The broadcast bus 309, the CDMA 310, and the GDMA 311 are used for performing the communication between the processor cores 306, the communication between the clusters 305, and data transfer between the clusters 305 and the DRAM 204, respectively. The above will be explained separately below.

The broadcast bus 309 is used for completing high-speed communication between the processor cores 306 in the clusters 305. The broadcast bus 309 of this embodiment supports inter-core communication modes including unicast, multicast, and broadcast. The unicast refers to point-to-point (single processor core-to-single processor core) data transfer. The multicast refers to a communication mode for transferring one copy of data from the SRAM 308 to a certain number of processor cores 306. The broadcast refers to a communication mode for transferring one copy of data from the SRAM 308 to all processor cores 306. The broadcast is a special case of the multicast.

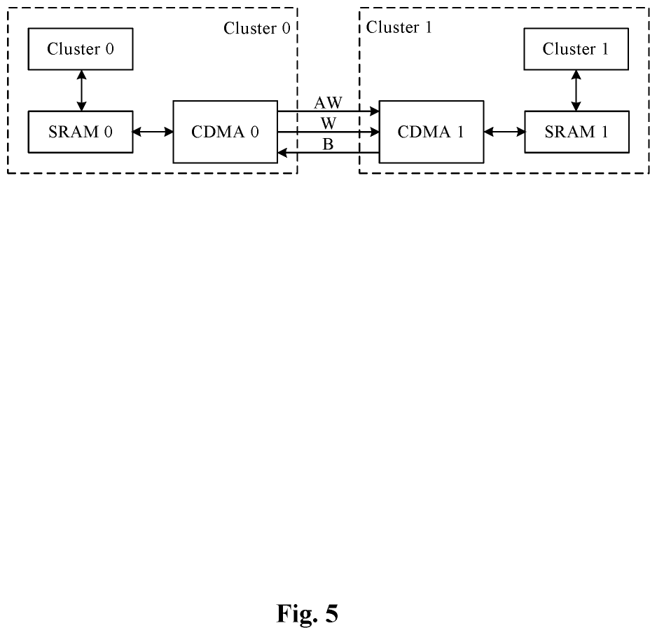

The CDMA 310 is used for controlling memory accesses of the SRAM 308 between different clusters 305 in the same computing apparatus 201. FIG. 5 is a schematic diagram that a processor core intends to write data to a processor core of another cluster, so as to illustrate the working principle of the CDMA 310. In this application scenario, the same computing apparatus includes a plurality of clusters. For the sake of explanation, only a cluster 0 and a cluster 1 are shown in the figure. The cluster 0 and the cluster 1 include a plurality of processor cores, respectively. Similarly, for the sake of explanation, the cluster 0 shows only a processor core 0 in the figure, and the cluster 1 shows only a processor core 1 in the figure. The processor core 0 intends to write data to the processor core 1.

First, the processor core 0 sends a unicast write request to write the data to a local SRAM 0. A CDMA 0 serves as a master end, and a CDMA 1 serves as a slave end. The master end sends the write request to the slave end. In other words, the master end sends a write address AW and write data W and sends the data to an SRAM 1 of the cluster 1. Next, the slave end sends a write response B in response. Finally, the processor core 1 of the cluster 1 sends a unicast read request to read the data from the SRAM 1.

Going back to FIG. 3, the GDMA 311 works with the external storage controller 301. The GDMA 311 is used for controlling memory accesses from the SRAM 308 to the DRAM 204 in the clusters 305, or the GDMA 311 is used for reading the data from the DRAM 204 to the SRAM 308 in the clusters 305. It may be known from the above that communication between the DRAM 204 and the NRAM 431 or the WRAM 432 may be implemented through two channels. A first channel is to directly connect the DRAM 204 with the NRAM 431 or the WRAM 432 through the IODAM 433. A second channel is to transfer the data between the DRAM 204 and the SRAM 308 through the GDMA 311 first, and then to transfer the data between the SRAM 308 and the NRAM 431 or the WRAM 432 through the MVDMA 434. Although it seems that the second channel requires more components and longer data streams, in fact, in some embodiments, the bandwidth of the second channel is much greater than that of the first channel. Therefore, the communication between the DRAM 204 and the NRAM 431 or the WRAM 432 may be more efficient through the second channel. Embodiments of the present disclosure may select a data transfer channel according to hardware conditions.

In other embodiments, a function of the GDMA 311 and a function of the IODMA 433 may be integrated in the same component. For the sake of description, the GDMA 311 and the IODMA 433 are viewed as different components in the present disclosure. For those skilled in the art, as long as functions and technical effects realized by components are similar to those of the present disclosure, the components shall fall within the scope of protection of the present disclosure. Further, the function of GDMA 311, the function of IODMA 433, a function of CDMA 310, and a function of MVDMA 434 may also be implemented by the same component. Similarly, as long as functions and technical effects realized by a component are similar to those of the present disclosure, the component shall fall within the scope of protection of the present disclosure.

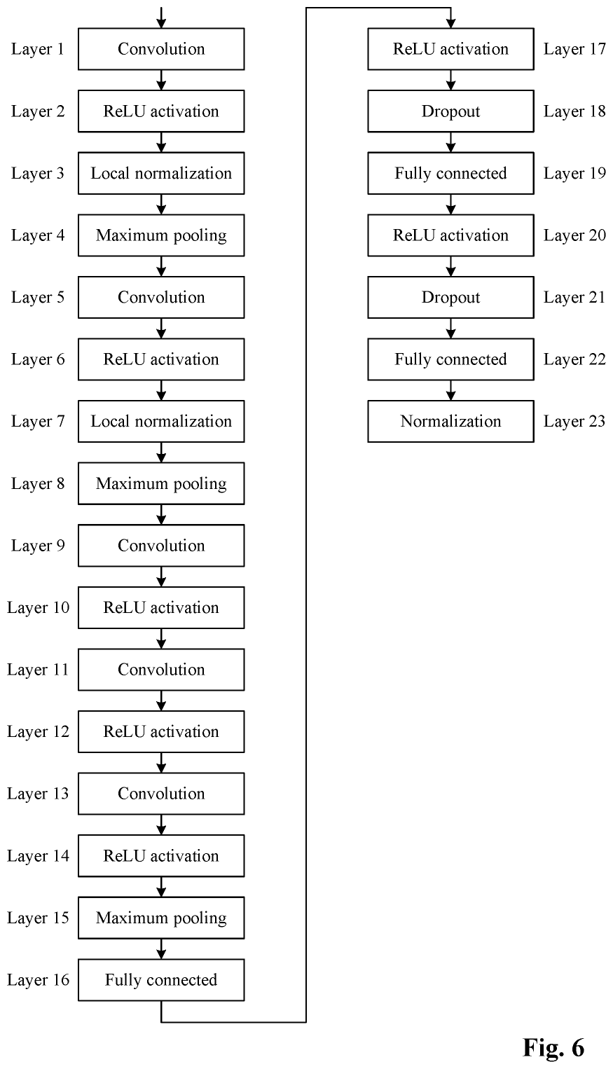

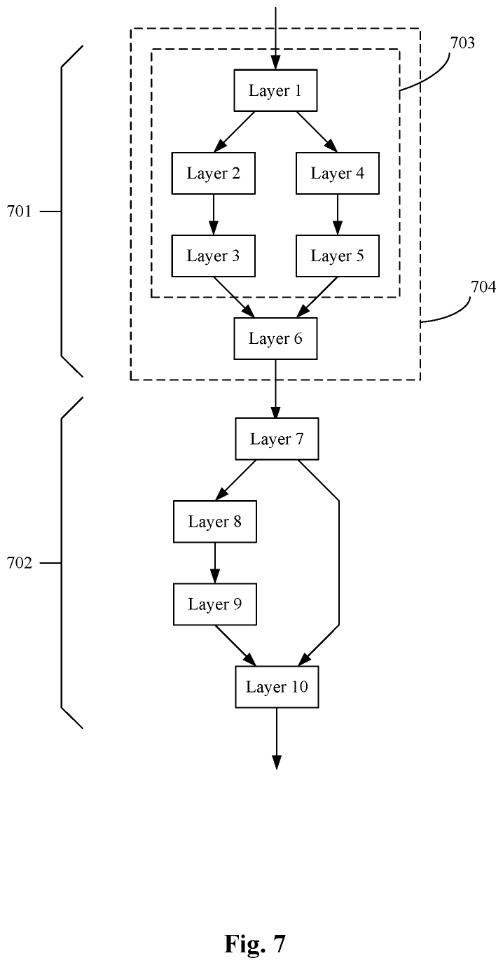

Neural network structures related to the present disclosure fall into two categories: a long-chain structure and a block structure. The long-chain structure means that a neural network model is composed of layers concatenated by single chains. Each layer has only one input and one output, and the whole layer belongs to a single branch. For example, the neural network model may be a VGG16 model or an AlexNet model shown in FIG. 6. The block structure means that a sub-network in the neural network has only one input and one output, however, the sub-network has multiple branches. In other words, part of layers of the sub-network have a plurality of inputs or a plurality of outputs. For example, the block structure may be a resblock structure of resnet50 and a block structure of inception_v3. FIG. 7 is a schematic diagram of an exemplary neural network model. This exemplary neural network model includes a sub-network 701 and a sub-network 702. The sub-network 701 has only one input and one output and includes layers 1 to 6. Layer 1 has two outputs, and layer 6 has two inputs. Therefore, the sub-network 701 includes two branches. One branch is layer 1→layer 2→layer 3→layer 6, another branch is layer1→layer 4→layer 5→layer 6. The sub-network 701 constitutes one block structure. Similarly, the sub-network 702 constitutes one block structure.

In performing deep learning computing at each layer, a lot of off-chip and on-chip accesses may be required. Especially, input data is read from the DRAM 204 to the computing apparatus 201, and then, a computing result of the computing apparatus 201 is stored to the DRAM 204. This kind of frequent access consumes a lot of hardware resources. In order to solve this problem, the present disclosure fuses adjacent layers of the neural network, which reduces off-chip and on-chip data transfer to a large extent.

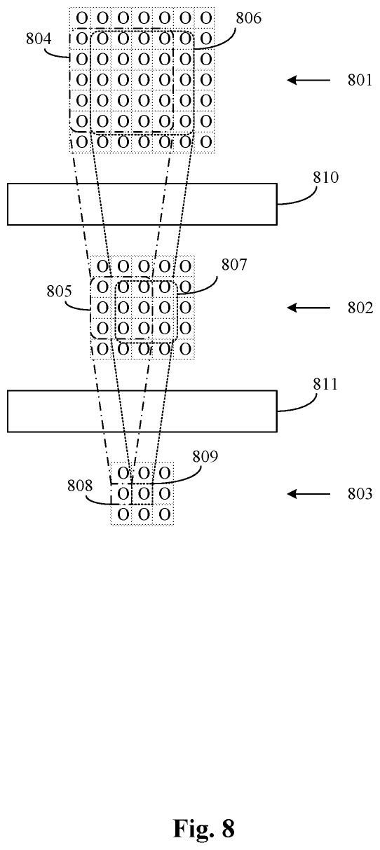

FIG. 8 is a schematic diagram that two convolution layers are fused together. An input of a first-layer convolution layer 810 is a 7×7 feature map 801. After this layer convolves the feature map 801 with a 3×3 kernel (which is not shown), a feature map 802 of the first-layer convolution layer 810 is obtained. A value of a 5×5 feature sub-map 804 may affect a 3×3 feature sub-map 805. Assuming that a stride is 1, after computing the 5×5 feature sub-map 804, the first-layer convolution layer 810 continues to compute a 5×5 feature sub-map 806. However, a value of the 5×5 feature sub-map 806 may affect a 3×3 feature sub-map 807.

In performing computing of a second-layer convolution layer 811, the feature map 802 becomes an input of the second-layer convolution layer 811. Similarly, after the feature map 802 is convolved with the 3×3 kernel, a feature map 803 of the second-layer convolution layer 811 is obtained. A value of the 3×3 feature sub-map 805 may affect a 1×1 feature sub-map 808 in the feature map 803. After computing the 3×3 feature sub-map 805, the second-layer convolution layer 811 continues to compute the 3×3 feature sub-map 807. However, a value of the 3×3 feature sub-map 807 may affect a 1×1 feature sub-map 809 in the feature map 803.

If the layers are not fused, in performing computing of the first-layer convolution layer 810, the computing apparatus 201 reads the 5×5 feature sub-map 804 from the DRAM 204. After the computing, the computing apparatus 201 stores the 3×3 feature sub-map 805 back to the DRAM 204. Next, the computing apparatus 201 reads the 5×5 feature sub-map 806 from the DRAM 204. After the computing, the computing apparatus 201 stores the 3×3 feature sub-map 807 to the DRAM 204. In performing computing of the second-layer convolution layer 811, similarly, it is required to read the 3×3 feature sub-map 805 from the DRAM 204. After the computing, it is required to store the 1×1 feature sub-map 808 to the DRAM 204. Next, it is required to read the 3×3 feature sub-map 807 from the DRAM 204. After the computing, it is required to store the 1×1 feature sub-map 809 to the DRAM 204. It may be known from the above explanation that the feature map 802, as intermediate data, is repeatedly read and stored on the chip and off the chip, which extremely occupies system resources.

If the first-layer convolution layer 810 and the second-layer convolution layer 811 are fused, which means to store the feature map 802 to the NRAM 431 (weights of the first-layer convolution layer 810 and the second-layer convolution layer 811 may also be stored in the WRAM 432), the number of accesses between the computing apparatus 201 and the DRAM 204 may be reduced, thereby improving execution efficiency of the whole neural network. Since the feature maps (such as the feature map 801, the feature map 802, and the feature map 803) involved in fusion look like an inverted pyramid in the context logic of the neural network model as a whole, the fusion is called a pyramid fusion.

The pyramid fusion is usually a backward fusion based on a specific convolution layer and a specific pooling layer in the neural network. In other words, a starting layer of the fusion is the convolution layer or the pooling layer, and according to hardware conditions, the layer backward fuses a plurality of layers which may contain a plurality of convolution layers and a plurality of pooling layers. However, with the development of deep learning and neural networks, the ordering of layers become complex. For example, an activation layer is set before the convolution layer, and therefore, how the activation layer is fused with the convolution layer behind should also be considered. Therefore, in addition to simply taking the convolution layer and the pooling layer as the core for fusion, the present disclosure provides various fusion methods, which do not necessarily take the convolution layer and the pooling layer as the core. Instead, a specific policy is adopted to flexibly select each layer of the neural network for fusion. Even a user-defined layer may be fused as long as the layer complies with the fusion policy, so as to optimize the overall efficiency.

Another embodiment of the present disclosure shows a new kind of fusion method. This kind of fusion method is implemented by using hardware structures of FIG. 1, FIG. 2, FIG. 3, and FIG. 4 described above. This kind of fusion is called a template fuse unit (TFU). The template fuse unit mainly fuses a plurality of layers into one layer flexibly through a certain fusion policy, so as to reduce input/output overheads of the network. The template fuse unit includes the pyramid fusion and other fusion methods described above. The collection of these fused layers is called the template fuse unit and is viewed as a new layer or a self-defined layer.

This embodiment loads a feature map and a weight required by the template fuse unit from the DRAM 204 to the SRAM 308 on the chip at a time. After the feature map is loaded into the SRAM 308, the feature map is called an on-chip unit map. The on-chip unit map may be cut into sub-maps. One sub-map is loaded from the SRAM 308 to the NRAM 431 of the processor core 306 assigned to compute this sub-map every time, and a weight required for computing this sub-map is also loaded from the SRAM 308 to the WRAM 432. After each sub-map is computed, a corresponding intermediate result is obtained. The intermediate result is saved back to the SRAM 308. After all sub-maps are computed, computing results are stored back to the DRAM 204 at a time. In other words, a corresponding result obtained by an operation of an operator in the neural network model by the on-chip unit and the weight is transferred between the DRAM 204 and the SRAM 308. An output (an intermediate result) corresponding to the sub-map is transferred between the SRAM 308 and the NRAM 431. From the perspective of the computing apparatus 201, data loading of the template fuse unit is in units of on-chip unit maps, while computing of the template fuse unit is in units of sub-maps.

More specifically, the SRAM 308 is one of important reference indexes of the fusion policy. A size of space of the SRAM 308 determines whether the template fuse unit is a large map mode or a small map mode. The small map mode and the large map mode refer to whether a feature map stored in the DRAM 204 may be moved to the SRAM 308 for processing at a time. The processing apparatus 203 compares storage space required by the feature map with available space of the SRAM 308. If the space of the SRAM 308 is insufficient to hold the feature map, the template fuse unit is the large map mode. If the space of the SRAM 308 is large enough to hold the whole feature map, the template fuse unit is the small map mode. It is required to be noted that in the large map mode, the on-chip unit map is just a part of the feature map, while in the small map mode, if the available space of the SRAM 308 is large enough, or the feature map is small enough, the SRAM 308 may be possible to hold a plurality of feature maps at a time. In other words, the on-chip unit map may include the plurality of feature maps.

If the template fuse unit is the large map mode, the feature map must be split before the feature map may be loaded into the computing apparatus 201. The processing apparatus 203 splits the feature map in the DRAM 204 until an on-chip unit map that is small enough to meet the space requirements of the SRAM 308 is generated, so that the on-chip unit map may be moved to the SRAM 308 for processing at a time. When the feature map is split, an input-dependent operation and an output-dependent operation may be generated.

The input-dependent operation means that on-chip unit maps after splitting are at least partly overlapped, and each sub-set requires some additional copies of inputs to perform a complete operation, resulting in data redundancy during a split operation. The so-called data redundancy means that the same piece of data is reused in the system. When the template fuse unit includes convolution, pooling, or matrix multiplication and other layers, the input-dependent operation is generated.

The output-dependent operation means that, after each sub-map produces an intermediate result, reduction is also required to obtain computing results. Reduction refers to splitting the on-chip unit map into sub-maps to perform computing respectively based on the understanding of the content of the on-chip unit map itself, so as to reduce the scale of computing. As such, on the premise of keeping the original appearance of the on-chip unit map as much as possible, the amount of data is reduced to the maximum extent, and then, the computing results are restored or integrated based on the sub-maps. The computing results are mutually dependent during the reduction. When the template fuse unit includes an inner product layer, a convolution layer, a matrix multiplication layer, a sorting layer, a counting layer, and the like, the output-dependent operation is generated.

Data formats of the feature maps that may be processed by this embodiment include N, H, W, C dimensions, where N represents a batch, H represents a height, W represents a width, and C represents a channel. Taking image data as an example, N represents the number of images in the batch; H represents the number of pixels of this image in the vertical direction; W represents the number of pixels of this image in the horizontal direction; and C represents the number of channels (for example, the number of channels C of a black-and-white image is 1, and the number of channels C of an RGB color image is 3).

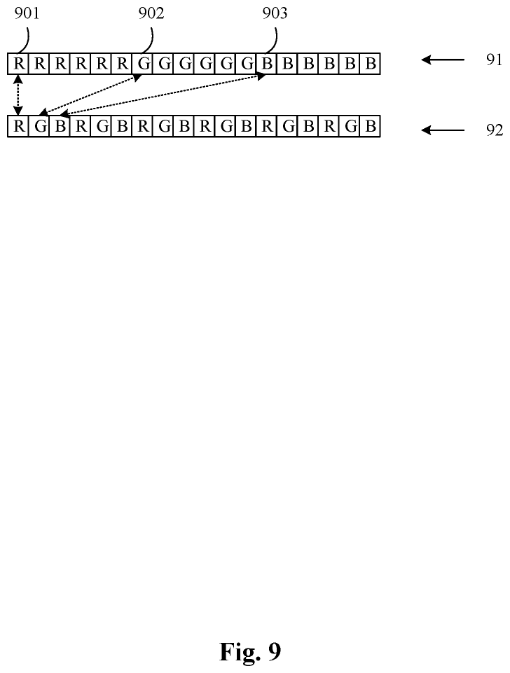

The ordering of these dimensions determines how the data is composed. Common composition methods include NHWC and NCHW. FIG. 9 shows format differences between NCHW and NHWC. This figure takes an RGB color image as an example. In this figure, R represents a red pixel, G represents a green pixel, and B represents a blue pixel. A sequence 91 is in the NCHW format. N is arranged in the outer layer. Pixels in each channel are close together and then arranged according to the order of RGB. An offset of an element whose coordinates are (n, c, h, w) in storage is ((n×C+c)×H+h)×W+w. A sequence 92 is in the NHWC format. C is arranged in the innermost layer. RGB pixels of space positions corresponding to a plurality of channels are close together. The figure also shows positions of an input pixel 901, an input pixel 902, and an input pixel 903 in different arrangements. However, the input pixel 901, the input pixel 902, the input pixel 903 together are the color of a point in the image. A conversion method for a coordinate offset corresponding to an element whose coordinates are (n, c, h, w) is ((n×H+h)×W+w)×C+c. First, the NHWC is closer to the image data storage format of Bitmap (BMP) than the NCHW. A file in the BMP format stores data pixel by pixel, and each pixel stores color values of all channels, which makes it unnecessary to carry out additional dimension conversions when reading input images. Therefore, the NHWC has better memory access locality, and through every three input pixels, one output pixel is obtained. However, the NCHW obtains a final output result only after all channel inputs are ready, which requires large cache space.

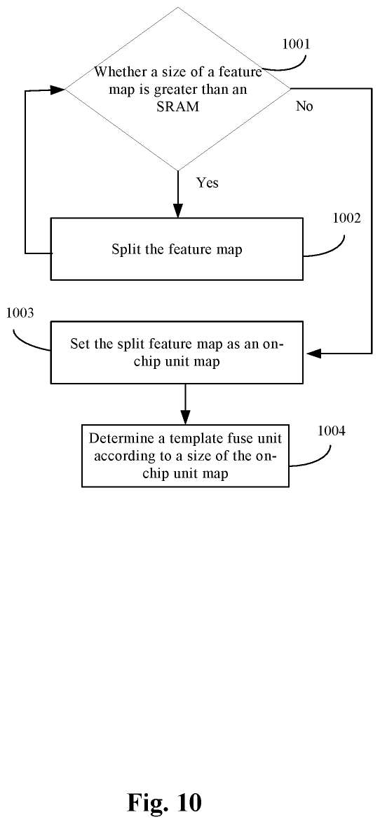

In this embodiment, each layer of the neural network may be fused as the template fuse unit based on data. FIG. 10 shows a corresponding flowchart.

In a step 1001, the processing apparatus 203 judges whether the storage space required by the feature map is larger than the available space of the SRAM 308. If the storage space required by the feature map is larger than the available space of the SRAM 308, it is represented that the feature map may not be loaded into the SRAM 308 at a time. Therefore, a step 1002 is performed to split the feature map. In this embodiment, the processing apparatus 203 preferentially chooses to split in the N dimension because no input-dependent operation or output-dependent operation will be generated. If splitting in the N dimension fails to meet the requirements, then, splitting in the H or W dimension is considered. At this time, the input-dependent operation or the output-dependent operation may be generated. This embodiment also supports splitting in the C dimension, especially splitting along a Cout direction. As such, one convolution is split into multiple convolution by means of data optimization, which allows the WRAM 432 to hold the weight. For example, the weight is split onto four processor cores 306. Therefore, as long as splitting in a certain dimension is processable by the computing apparatus 201, the splitting shall fall within the scope of the present disclosure.

Further, the processing apparatus 203 may perform splitting among the N, H, and W dimensions with specific granularity in order. The specific granularity may be a fixed ratio or a variable ratio, or the specific granularity may be represented by a function. In an application scenario, the processing apparatus 203 splits the feature map or the weight in an order from large to small. Taking the feature map as an example, first, a feature map whose dimension is NHWC is split into a feature map whose dimension is N₁HWC and a feature map whose dimension is N₂HWC in the N dimension, where the specific granularity is the fixed ratio, and N₁ and N₂ are each half of N. If the feature map is not small enough, the processing apparatus 203 continues to split the feature map whose dimension is N₁HWC into a feature map whose dimension is N₁H₁WC and a feature map whose dimension is N₁H₂WC in the H dimension, where H₁ and H₂ are each half of H. If the feature map is not small enough, the processing apparatus 203 continues to split the feature map whose dimension is N₁H₁WC into a feature map whose dimension is N₁H₁W₁C and a feature map whose dimension is N₁H₁W₂C in the W dimension, where W₁ and W₂ are each half of W. The processing apparatus 203 may continue splitting in the N, W, and H dimensions with smaller granularity, such as quarter, eighth, or sixteenth cuts, until the feature map is small enough and becomes an on-chip unit map that may be loaded into the SRAM 308 at a time.

It may be understood that the processing apparatus 203 may continue splitting in one dimension until the feature map may no longer be split, and then, the processing apparatus 203 selects another dimension to continue splitting. For example, the processing apparatus 203 continues splitting in the H dimension. If the feature map is split into the smallest unit, while the feature map still may not be loaded into the SRAM 308, then, the processing apparatus 203 performs splitting in the W dimension until the feature map is split into the smallest unit.

It is required to note that, since such a splitting method is to split in an order from large to small, when a split feature map meets conditions, a size of storage space required by the split feature map is usually almost the same as the available space of the SRAM 308. In other words, in the large map mode, the DRAM 204 may transfer only one split feature map to the SRAM 308 every time. However, in the small map mode, the space of the SRAM 308 may load a plurality of feature maps from the DRAM 204 at a time.

In another application scenario, the processing apparatus 203 performs splitting in an order from small to large. Similarly, the specific granularity may be the fixed ratio or the variable ratio, or the specific granularity may be represented by the function. For example, first, the processing apparatus 203 performs splitting in the N dimension with the smallest unit as the specific granularity, which is 1×H×W×C. If the SRAM 308 may load the feature map, the processing apparatus 203 continues enlarging the splitting of the feature map. For example, the processing apparatus 203 enlarges the splitting of the feature map as 2×H×W×C. If the SRAM 308 may still load the feature map, the processing apparatus 203 continues enlarging the splitting of the feature map until n×H×W×C may not be loaded. Then, a size of the on-chip unit map is (n−1)×H×W×C.

If storage space required by 1×H×W×C exceeds the available space of the SRAM 308, the processing apparatus 203 continues splitting in another dimension. For example, starting from the H dimension, the processing apparatus 203 continues to judge 1×1×W×C. If the feature map is small enough, the processing apparatus 203 enlarges the feature map along the H dimension until the storage space required by 1×(h−1)×W×C is exactly close to, but is not larger than, the available space of the SRAM 308. If the storage space required exceeds the available space of the SRAM 308, then, the processing apparatus 203 continues splitting in another dimension, such as the W dimension. The processing apparatus 203 performs the splitting successively until optimal input data that may be loaded into the SRAM 308 at a time is found. Here, “optimal” means that the storage space required by the on-chip unit map is closest to, but is not larger than, the available space of the SRAM 308.

After the processing apparatus 203 splits the feature map, this process goes back to the step 1001. The processing apparatus 203 judges whether storage space required by the split feature map is still larger than the available space of the SRAM 308. If the storage space required by the split feature map is still larger than the available space of the SRAM 308, the step 1002 is performed again to continue splitting.

If the processing apparatus 203 judges that the storage space required by the split feature map is not larger than the available space of the SRAM 308, it is represented that the SRAM 308 may load the split feature map at a time. Then, a step 1003 is performed, and the processing apparatus 203 sets the split feature map as the on-chip unit map.

Finally, a step 1004 is performed, and the processing apparatus 203 determines the template fuse unit according to the size of the on-chip unit map. This step will be explained in detail later.

In other application scenarios, when the processing apparatus 203 performs the step 1001 and the step 1002 for several times, it is represented that the storage space required by the split feature map is getting closer to the available space of the SRAM 308. For example, assuming that the storage space required by the feature map is 100 k and the available space of the SRAM 308 is 40 k, in the step 1001, the processing apparatus 203 judges that the storage space required by the feature map is larger than the available space of the SRAM 308. Therefore, the step 1002 is performed to split the feature map into half along the N dimension. At this time, the split feature map is 50 k, and then, this process goes back to the step 1001. The storage space required by the split feature map is still larger than the available space of the SRAM 308, and then, the step 1002 is performed to split the feature map into half again along the N dimension. At this time, the split feature map is 25 k, and then, this process goes back to the step 1001. The storage space required by the split feature map is smaller than the available space of the SRAM 308, and then, the step 1003 is performed, and the processing apparatus 203 sets the split feature map (whose size is 25 k) as the on-chip unit map.

The available space of the SRAM 308 is 40 k, while the storage space required by the on-chip unit map is 25 k. There is still 15k of idle space. The reason is that the splitting is performed by taking one half as a unit in the step 1002, so that the granularity of the last splitting is too large. This embodiment may gradually reduce the specific granularity of the splitting with the number of times of splitting, so that the storage space required by the on-chip unit map after the splitting is as close as possible to the available space of the SRAM 308. For example, the specific granularity may be set to half at the beginning. Next, the specific granularity may be set to three quarters. Finally, the specific granularity may be set to four fifths. Similarly, taking a case where the storage space required by the feature map is 100 k and the available space of the SRAM 308 is 40 k as an example, in the step 1001, the processing apparatus 203 judges that the storage space required by the feature map is larger than the available space of the SRAM 308. Therefore, the step 1002 is performed. At this time, the specific granularity is set to half, and the split feature map is 50 k. Then, this process goes back to the step 1001. At this time, the storage space required by the split feature map is still larger than the available space of the SRAM 308, and then, the step 1002 is performed. At this time, the specific granularity is set to three quarters, and the split feature map is 37.5 k. Then, this process goes back to the step 1001. At this time, the storage space required by the split feature map is smaller than the available space of the SRAM 308. Therefore, the step 1003 is performed, and the processing apparatus 203 sets the split feature map (whose size is 37.5 k) as the on-chip unit map. 37.5 k is closer to 40 k than 25 k. The latter method makes better use of the available space of the SRAM 308 and is more efficient. This embodiment does not limit the size of the specific granularity, and the specific granularity may be set according to application scenarios.

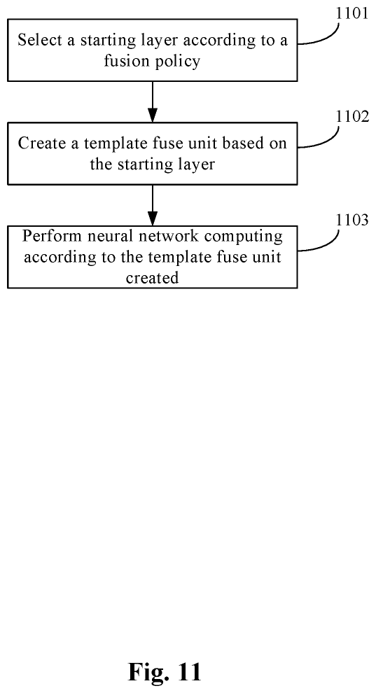

After the size of the on-chip unit map is determined, the step 1004 is performed. This step is to dynamically fuse the neural network according to the fusion policy. FIG. 11 shows a method of dynamically fusing the neural network according to the fusion policy in this embodiment.

In a step 1101, a starting layer of the template fuse unit is selected according to a starting rule of the fusion policy. The processing apparatus 203 selects the starting layer of the template fuse unit according to the starting rule of the fusion policy. In other words, the processing apparatus 203 selects a layer that starts to fuse among unfused layers in the neural network.

In an application scenario, the starting rule means that the starting layer is a top unfused layer in the neural network. The processing apparatus 203 searches for the top unfused layer. Taking an AlexNet neural network model in FIG. 6 as an example, the model has a total of 23 layers. Assuming that layers 1 to 5 are fused, when the starting rule means that the starting layer is the top unfused layer in the neural network, the processing apparatus 203 selects a ReLU activation layer of layer 6 as the starting layer and fuses backward (in other words, the processing apparatus 203 performs a fusion in a direction of layer 7). It is required to be noted that, under this starting rule, the starting layer is not necessarily a convolution layer or a pooling layer.

In another application scenario, considering that the convolution layer and the pooling layer consume the most input/output resources, the starting rule is that the starting layer is a top unfused convolution or pooling layer. The processing apparatus 203 finds all the convolution and pooling layers of unfused layers in the neural network model first, and then, the processing apparatus 203 fuses backward starting from the top unfused convolution or pooling layer. Similarly, taking the AlexNet neural network model in FIG. 6 as an example, assuming that layers 1 to 9 are fused, the processing apparatus 203 finds all the convolution and pooling layers of the unfused layers in the neural network model, which are layer 11, layer 13, and layer 15. Next, the processing apparatus 203 starts the fusion from the top unfused convolution or pooling layer. In other words, the starting layer is layer 11.

In a step 1102, a fusion is performed based on the starting layer, and all rules of the fusion policy are checked one by one to create the template fuse unit. The processing apparatus 203 performs the fusion based on the starting layer and checks all rules of the fusion policy one by one, so as to create the template fuse unit. On the premise that all rules are satisfied, hardware resources of the computing apparatus 201 are sufficient to load data required for computing the template fuse unit at a time and then perform neural network computing according to the template fuse unit. In addition to the starting rule, the fusion policy may also include following rules for example.

Rule 1: Fusing Backward

Fusing backward is to fuse in a direction of neural network model inference starting from the starting layer. Taking FIG. 6 as an example, fusing backward is to fuse in a direction of layer 1→layer 2→layer 3. If there are unfused layers before the starting layer, under this rule, these unfused layers will not be considered to be incorporated into the template fuse unit.

Rule 2: Preferentially Fusing Forward

Fusing forward is to fuse in a reverse direction of neural network inference starting from the starting layer. Taking FIG. 6 as an example, fusing forward is to fuse in a direction of layer 3→layer 2→layer 1. This rule is usually matched with the starting rule that the starting layer is the top unfused convolution or pooling layer. The reason is that there may be unfused layers before the convolution or pooling layer. After the starting layer is selected, the processing apparatus 203 preferentially fuses forward to try to incorporate the unfused layers before the starting layer into the template fuse unit. Similarly, taking the AlexNet neural network model in FIG. 6 as an example, assuming that layers 1 to 2 are fused, the processing apparatus 203 founds that the top unfused convolution or pooling layer is layer 5. Therefore, the starting layer is layer 5, and the processing apparatus 203 preferentially forward fuses layer 4 and layer 3. If the fusion may continue, the processing apparatus 203 backward fuses layer 6 and layer 7, and the like.

Rule 3: Preferentially Taking a Block Structure as a Unit

When the neural network model has a block structure, this rule requires the processing apparatus 203 to preferentially add and delete the template fuse unit by the block structure rather than by the layer. If the fusion of operation logic of the whole block fails, then, a fusion from layers on each branch is considered. Taking a neural network model in FIG. 7 as an example, the processing apparatus 203 preferentially takes a sub-network 701 or a sub-network 702 as a unit to perform the fusion.

When the neural network is a long-chain structure, since there is no block structure, the processing apparatus 203 directly adds and deletes the template fuse unit by the layer. This rule is not applicable to the neural network model with the long-chain structure.

Rule 4: Single-Branch Output

The fusion policy of this embodiment does not support that the template fuse unit is a multi-output network. The reason is that shape derivation inside the template fuse unit mainly adopts a derivation form from back to front. The multi-output network means that it is required to forward derive respectively from different outputs, and results of the derivation do not necessarily come down to the same feature map, so that the results may not be converged.

In other words, the output of the template fuse unit is required to be the single-branch output, which means that the last layer of the template fuse unit may only have one output. FIG. 7 shows two fusion methods of a sub-network 701. A first method is to fuse layers 1 to 5 into a template fuse unit 703. A second method is to fuse layers 1 to 6 into a template fuse unit 704. Since outputs of layer 3 and layer 5 are outputs of the template fuse unit 703, the template fuse unit 703 belongs to a multi-output network. In other words, the template fuse unit 703 has a multi-branch output. However, an output of layer 6 is an output of the template fuse unit 704, and only one piece of output data is generated. Therefore, the template fuse unit 704 belongs to a single-output network. In other words, the template fuse unit 704 has a single-branch output. The processing apparatus 203 judges whether the output of the template fuse unit is the single-branch output. If this rule is not satisfied, the processing apparatus 203 adds and deletes layers in the template fuse unit until this rule is satisfied.

Rule 5: Including at Least Two Main Layers

When layer logic is too simple, performance of the template fuse unit is not as good as performance of the unfused layers. Therefore, when the layer logic is used as the fusion policy, the processing apparatus 203 evaluates whether an operation of each fused layer is complicated enough to enable the fusion to produce benefits. In order to produce benefits, it is required to incorporate a main layer into the template fuse unit as much as possible. The main layer refers to a layer that consumes a lot of input/output resources, such as matrix multiplication, pooling, or convolution. Here, the pooling includes various kinds of pooling, such as maximum pooling (maxpool) or average pooling (avgpool). The convolution includes various kinds of convolution, such as ordinary convolution, convolution with a mean, depthwise convolution (depthwise cony), and the like. This rule is that the template fuse unit includes at least two main layers. When the processing apparatus 203 judges that this rule is not satisfied, the processing apparatus 203 adjusts the template fuse unit until this rule is satisfied.

Rule 6: Including a Continuous Structure in which a Main Layer, a Main Layer, and a Non-Main Layer are Successively Adjacent

This rule is that the template fuse unit is required to include a continuous structure of the main layer, the main layer, and the non-main layer. In other words, the template fuse unit is required to include the continuous structure in which the main layer, the main layer, and the non-main layer are successively adjacent. Such operations are complicated enough to enable the fusion to produce benefits. With reference to layer 4-layer 5-layer 6 in FIG. 6, where layer 4 is a maximum pooling layer, layer 5 is a convolution layer, and layer 6 is a ReLU activation layer, such a structure conforms to the continuous structure in which the main layer, the main layer, and the non-main layer are successively adjacent. Therefore, a template fuse unit including layer 4, layer 5, and layer 6 satisfies this rule. When the processing apparatus 203 judges that this rule is not satisfied, the processing apparatus 203 adjusts the template fuse unit until this rule is satisfied.

Rule 7: Including a Continuous Structure in which a Scalar Computing Layer and a Vector Computing Layer are Adjacent

This rule is that the template fuse unit includes a continuous structure of the scalar computing layer and the vector computing layer. In other words, the template fuse unit includes the continuous structure in which the scalar computing layer and the vector computing layer are adjacent. The scalar computing layer refers to an addition layer, a subtraction layer, or a multiplication layer. The vector computing layer refers to an activation layer, a batch normalization layer, or a scaling layer. When the processing apparatus 203 judges that this rule is not satisfied, the processing apparatus 203 adjusts the template fuse unit until this rule is satisfied.

Rule 8: A Weight of a Convolution Layer is not an Output of a Certain Layer

This rule is that the weight of the convolution layer in the template fuse unit is not an output of any layer of the neural network, no matter whether this layer is incorporated into the template fuse unit or not. When the processing apparatus 203 judges that this rule is not satisfied, the processing apparatus 203 removes this convolution layer from the template fuse unit.

Rule 9: A Weight of a Convolution Layer is not Shared with any Layer of a Neural Network

Since a weight of an operator of a neural network model involved in the template fuse unit has a special arrangement form, when a fused convolution operator shares a weight with other operators, arrangement logic of the weight will conflict. This rule is that the weight of the convolution operator in the template fuse unit is not shared with any layer of the neural network. When the processing apparatus 203 judges that this rule is not satisfied, the processing apparatus 203 removes this convolution operator from the template fuse unit.

Rule 10: a weight is not larger than available space of a WRAM

The large map mode has fewer restrictions on the WRAM 432. The reason is that an on-chip unit map that is loaded into the SRAM 308 is only a part of a feature map, and when computing the template fuse unit, the WRAM 432 is only required to store all weights of this feature map. However, since a plurality of feature maps may be loaded into the SRAM 308 in the small map mode, in this situation, required weights will be increased, whether the available space of the WRAM 432 is sufficient should be evaluated more carefully. This rule is that storage space required by the weight in the on-chip unit map is not larger than the available space of the WRAM 432. When the processing apparatus 203 judges that this rule is not satisfied, the processing apparatus 203 reduces a size of the on-chip unit map.

If the weight is split based on an output channel parameter Cout of the C dimension, since the weight will be averagely distributed among a plurality of processor cores 306, this rule is adjusted as:

$$\frac{{W}_{j}}{n} \leq W$$

Wⱼ refers to storage space required by a weight involved in an on-chip unit map j, n refers to the number of processor cores in a cluster, and W refers to the available space of the WRAM 432.

Rule 11: Redundancy Percentage

The redundancy percentage refers to a ratio of a sum of redundancy generated by the input-dependent operation and the output-dependent operation to the amount of normal input/output of the template fuse unit. Here, the amount of normal input/output refers to the amount of data of the on-chip unit map without redundancy before splitting. The processing apparatus 203 computes a percentage of the amount of memory access size_{TFU} of the on-chip unit map from the DRAM 204 to the SRAM 308 to the amount of normal input/output (excluding redundancy) sizeₒᵣᵢ after the template fuse unit fuses a current layer. Here, the amount of memory access size_{TFU} refers to the theoretical amount of memory access sizeₒᵣᵢ plus a sum of redundancy. The formula is as follows:

$$\frac{( {size}_{TFU} - {size}_{ori} )}{{size}_{ori}} \times 100 \% \geq percentage threshold .$$

The processing apparatus 203 takes into account split information and shape derivation of the template fuse unit and sets the percentage threshold to 0%, 75%, 100%, 125%, or 150%, and preferably, the processing apparatus 203 sets the percentage threshold to 100%. For example, if the percentage threshold is 100%, it is represented that the sum of redundancy is more than twice of the amount of normal input/output of the template fuse unit, the fusion is not performed. This rule is that a sum of redundancy generated by splitting the on-chip unit map does not exceed a specific proportion associated with the percentage threshold. Once the sum of redundancy generated by splitting the on-chip unit map exceeds the specific proportion associated with the percentage threshold, it is represented that there are too many redundant parts, and a lot of resources are spent on computing redundancy, thus reducing efficiency. Therefore, when the processing apparatus 203 judges that this rule is not satisfied, the processing apparatus 203 stops the fusion.

It is required to be noted that, in the small map mode, since at least one complete feature map is loaded from the DRAM 204 to the SRAM 308 at a time, there is no redundancy. This rule is not applicable to the small map mode.

Rule 12: Input and Output Sizes of an On-Chip Unit Map

Assuming that a size of space of the SRAM 308 is S, storage space required by the on-chip unit map is IN, and storage space required by computing results of the on-chip unit map is OUT, then, this rule is that the size of the space of the SRAM 308 is required to satisfy following conditions.

If IN and OUT may not reuse the storage space, IN+OUT<S.

If IN and OUT may reuse the storage space, MAX(IN, OUT)<S.

In other words, if IN and OUT may not reuse the storage space, a sum of the storage space of the on-chip unit map and the storage space of the computing results is smaller than the available space of the SRAM 308; and if IN and OUT may reuse the storage space, the larger of the storage space of the on-chip unit map and the storage space of the computing results is smaller than the available space of the SRAM 308.

Rule 13: W₁+IN1+IN2≤S

In the small map mode, this rule is that the size of the space of the SRAM 308 is required to satisfy a following condition:

Wᵢ+IN1+IN2≤S

In other words, a sum of storage space Wᵢ required by a weight of a sub-map i, storage space IN1 required by the on-chip unit map, and caching space IN2 is not larger than the available space of the SRAM 308. When the processing apparatus 203 judges that this rule is not satisfied, the processing apparatus 203 decreases the number of on-chip unit maps until this rule is satisfied.

Rule 14: SubINi+Wᵢ+IN2≤S

In the small map mode, this rule is that the size of the space of the SRAM 308 is required to satisfy a following condition:

SubINi+Wᵢ+IN2≤S

In other words, a sum of storage space SubINi required by the sub-map i, the storage space Wᵢ required by the weight of the sub-map i, and the cache space IN2 is not larger than the available space of the SRAM 308. When the processing apparatus 203 judges that this rule is not satisfied, the processing apparatus 203 decreases the number of on-chip unit maps until this rule is satisfied.

Rule 15: SubOUTi+Wᵢ₊₁+IN2≤S

In the small map mode, this rule is that the size of the space of the SRAM 308 is required to satisfy a following condition:

SubOUTi+Wᵢ₊₁+IN2≤S

In other words, a sum of storage space SubOUTi required by intermediate results of the sub-map i, storage space Wᵢ₊₁ required by a weight of a next sub-map, and the cache space IN2 is not larger than the available space of the SRAM 308. When the processing apparatus 203 judges that this rule is not satisfied, the processing apparatus 203 decreases the number of on-chip unit maps until this rule is satisfied.

Rule 16: Wᵢ+Wᵢ₊₁≤W

A weight involved in a convolution operation in the template fuse unit is moved independently and resides on the WRAM 432. In the small map mode, if a sub-map includes a plurality of feature maps, considering pipelining between sub-maps, the WRAM 432 stores weights of two adjacent sub-maps at most simultaneously. Assuming that storage space required by each sub-map i is Wᵢ and total space of the WRAM 432 is W, this rule is that the size of the space of the WRAM 432 is required to satisfy a following condition:

Wᵢ+Wᵢ₊₁≤W

In other words, a sum of the storage space Wᵢ required by the weight of the sub-map i and the storage space Wᵢ₊₁ required by the weight of the next sub-map is not larger than the available space of the WRAM 432. When the processing apparatus 203 judges that this rule is not satisfied, the processing apparatus 203 decreases the number of on-chip unit maps until this rule is satisfied.

Rule 17: Storage Space Required by a Sub-Map is not Larger than Available Space of an NRAM

This rule is that the storage space required by the sub-map is not larger than the available space of the NRAM 431. When the on-chip unit map in the SRAM 308 is to be split into sub-maps and moved to the NRAM 431, the processing apparatus 203 may perform fine-grained splitting in the N, H, and W dimensions. If the space of the NRAM 431 is not enough, the processing apparatus 203 splits the on-chip unit map into finer pieces until this rule is satisfied. In general, the NRAM 431 has reasonable available space, so that the on-chip unit map is split to a reasonable degree to be loaded at a time. From the perspective of the fusion policy, the template fuse unit is not affected by the number of batches. However, the on-chip unit map is split more finely (there are more sub-maps), the processing speed will be decreased, so the processing apparatus 203 is required to evaluate the space of the NRAM 431.

In some embodiments, the space of the SRAM 308 corresponds to the number of NRAMs 431 of the processing cores 306 in the cluster 305. For example, the cluster 305 includes four processor cores 306, and then the space of the SRAM 308 is four times of the space of the NRAM 431. In other words, in the large map mode, the on-chip unit map may generally be allocated to four processor cores 306 for processing. This kind of architecture design has considered that data that is loaded into the SRAM 308 may be allocated to all NRAMs 431 at a time. Therefore, this rule is not required to be considered in the large map mode.

Rule 18: The Number of Feature Maps is not Greater than a Feature Map Threshold

In the small map mode, the on-chip unit map may include a plurality of feature maps. The more the feature maps, the more the number of times of transferring the sub-maps between the SRAM 308 and the NRAM 431, and the efficiency will be decreased. Therefore, it is not always better to include more feature maps in the on-chip unit map. The processing apparatus 203 may compute the appropriate number of fusion layers based on the number of feature maps in the on-chip unit map to maximize benefits. This rule is that the number of feature maps in the on-chip unit map is not greater than the feature map threshold. When the processing apparatus 203 judges that this rule is not satisfied, the processing apparatus 203 decreases the number of feature maps in on-chip data until this rule is satisfied.

Rule 19: Stride Redundancy

The stride redundancy means that, when the template fuse unit fuses too many layers, and the lengths of and widths of kernels of the convolution layer and the pooling layer are larger than strides, there is an overlap between input data required by each output point, which is the aforementioned input-dependent operation. This overlap is the stride redundancy. The stride redundancy makes each processor core 306 be required to read more data. However, this part of reused data may occupy on-chip and off-chip access resources. The more layers the template fuse unit includes, the more serious the stride redundancy is. This rule is that a sum of difference values between side lengths of the kernel of the convolution layer or the pooling layer and a stride of the kernel of the convolution layer or the pooling layer is not greater than a redundancy threshold.

In this embodiment, the definition of the redundancy threshold is as follows. Assuming that the length and width of the kernel of the convolution layer and the pooling layer are kₓ and k_{y}, and strides in the length and width directions are sₓ and s_{y} respectively, and then stride redundancy in the length direction is a sum of kₓ−sₓ of all the convolution layers and all the pooling layers in the template fuse unit. Similarly, stride redundancy in the width direction is a sum of k_{y}−s_{y} of all the convolution layers and all the pooling layers in the template fuse unit. The redundancy threshold of this embodiment may be 3, 4, 5, or 6, and preferably, the redundancy threshold may be 4. This rule is not satisfied as long as the stride redundancy in either of the length or width directions is greater than the redundancy threshold. The processing apparatus 203 adjusts the template fuse unit. Usually, the processing apparatus 203 decreases the number of layers that are fused until this rule is satisfied.

The fusion policy provides an exception rule for the stride redundancy. If there are multiple branches in the layer to be fused and the template fuse unit may fuse the entire multiple branches, the performance of the template fuse unit may be better. In this situation, the processing apparatus 203 ignores the rule for the stride redundancy, which means that the stride redundancy does not restrict the template fuse unit to fuse the multiple branches. In other words, in the fusion policy of this embodiment, fusing the multiple branches takes precedence over the restriction of the stride redundancy. In other words, the stride redundancy is only considered in the case of a single branch.

The above rules are only examples. The present disclosure does not restrict the order in which each rule is performed or the fact that these rules are required to be considered simultaneously. Those skilled in the art may add or delete the rules in different application scenarios based on actual situations to implement a fusion policy that meets a current application scenario.

Going back to FIG. 11, in a step 1103, neural network computing is performed according to the template fuse unit created. The computing apparatus 201, based on a three-level operation hierarchy of SoC-cluster-processor core, in combination with three-level memory design of DRAM-SRAM-NRAM/WRAM, takes the template fuse unit as a self-defined layer in the neural network and loads data required for computing the template fuse unit from the DRAM 204 to the SRAM 308 at a time. As such, the data may be cached and computed at appropriate levels, thereby forming sufficient pipelining. After computing, the computing apparatus 201 sends computing results from the SRAM 308 to the DRAM 204, which greatly reduces input/output overheads in the neural network computing.

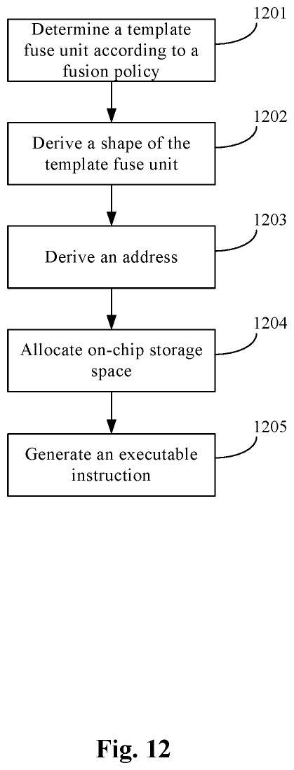

When input data from fields such as computer vision, speech, natural language processing, and data mining is intended for various deep learning algorithms and various machine learning algorithms, the present disclosure, based on the template fuse unit, may reduce the input/output overheads in the neural network computing. Another embodiment of the present disclosure shows a method of performing neural network computing by using a template fuse unit. FIG. 12 shows a process of this method.

In a step 1201, the template fuse unit is determined according to a fusion policy. The processing apparatus 203 selects a starting layer of the template fuse unit according to a starting rule of the fusion policy. Moreover, the processing apparatus 203 performs a fusion based on the starting layer and checks all rules of the fusion policy one by one, so as to create the template fuse unit. The previous embodiment has illustrated various rules of the fusion policy with examples in detail, which will not be repeated herein.

In this step, the template fuse unit may be represented in the form of a source code. Next, it is required to convert the source code into an object code of machine language, which is also known as machine code, through a compiler. The following steps show a process of converting the source code of the template fuse unit into the object code of the machine language by the compiler.

In a step 1202, a shape of the template fuse unit is derived. For data that is required to be processed by the template fuse unit, this embodiment adopts a method of reverse derivation. The compiler reversely derives forward from outputs what size of inputs is required. Taking FIG. 8 as an example, the compiler performs the reverse derivation from a feature map 803 to a feature map 802, and then to a feature map 801. In this step, the compiler not only derives required input data according to the template fuse unit, but also further derives redundancy.

Next, a step 1203 is performed to derive an address. According to the shape of the template fuse unit, the compiler derives an address of on-chip storage space of the whole control flow graph and implements access to a general address, so as to achieve the purpose of simplifying computing resources and shortening computing time. The control flow graph is an abstract data structure used in the compiler. The control flow graph represents all paths that a program may perform and reflects possible flow directions of all nodes in the process in the form of a flowchart. The control flow graph is composed of relationships between nodes. A node is also called a basic block (BB) and is a statement sequence that is performed sequentially to the maximum in the program. Each basic block has only one entrance and one exit. Data enters through the entrance and exits through the exit during execution. The characteristic of the basic block is that all instructions in the basic block are performed in order as long as a first instruction in the basic block is performed.

Each basic block includes at least one instruction. The instruction in the basic block may point to specific on-chip storage space by using a pointer. The pointer is a kind of variable and is used for saving an address of specific address space. Through the pointer, the processor cores 306 may load data into the space of the specific address pointed to by the pointer, or the processor cores 306 may fetch the data from the specific address pointed to by the pointer.

According to the division of the template fuse unit, the compiler initially divides basic blocks and then confirms the basic blocks and mutual relations between the basic blocks after iterative operations. At this point, the object code for implementing the template fuse unit is completed.

Not only that, the compiler also analyzes reused data of two front and back template fuse units in the neural network, judges how much data in a previous template fuse unit may be left on the chip for use by a next template fuse unit, and plans a storage address of each piece of data according to a judging result.

In this step, the compiler completes the derivation of the address in the control flow graph.

In a step 1204, on-chip storage space is allocated. The processing apparatus 203 allocates physical space for the SRAM 308, the NRAM 431, and the WRAM 432 based on the derivation of the address of the template fuse unit. In this step, the compiler completes the pointing of the pointer in the control flow graph.

Finally, a step 1205 is performed to generate an executable instruction. In this step, a linker links the object code generated by the compiler with a library, so as to make the object code into an executable file. More specifically, the object code is a program unit that includes a machine code and linker available information. The linker is used to parse undefined symbolic references, replace a placeholder in the object code with an address of a symbol, and then generate the executable instruction. The executable instruction may be performed directly by the computing apparatus 201 to complete the computing of the neural network.

By setting the fusion policy, the present disclosure dynamically determines the template fuse unit, fuses a plurality of layers in the neural network to form a new self-defined layer, and loads data required for computing the template fuse unit at a time, so as to reduce input/output overheads.

When the rules of the fusion policy mentioned above are used to determine the template fuse unit, it is not necessary to start the fusion with the convolution layer or the pooling layer. As mentioned in the above embodiment, in an application scenario, the starting rule may be that the starting layer is the top unfused layer in the neural network, and this layer may be a layer other than the convolution layer or the pooling layer. Such a starting rule makes the creation of the template fuse unit more flexible. For different neural networks, based on the ordering of each layer, the starting layer is appropriately selected to start the fusion, which is not limited by the positions and number of convolution layers or pooling layers in the neural network model, thereby adapting to various network models, making the fusion more comprehensive, and improving the overall benefit.

For example, taking the neural network model of FIG. 6 as an example, assuming that layers 1 to 5 are fused, when creating a next template fuse unit, if the starting rule is that the starting layer is the top unfused convolution or pooling layer, a next convolution or pooling layer is layer 8. In other words, layer 6 and layer 7 may not be fused, and the overall benefit may be affected.

Another embodiment of the present disclosure shows a solution of fusing the neural network, where the starting layer is the layer other than the convolution layer and the pooling layer; in other words, the starting layer is a non-convolution layer and a non-pooling layer. This embodiment is also implemented based on the framework shown in FIGS. 1-4. This embodiment also performs the flowchart shown in FIG. 11.

In the step 1101, the starting layer is selected according to the fusion policy. The processing apparatus 203 selects the starting layer according to the fusion policy. For example, the starting rule of the fusion policy is that the starting layer is the top unfused layer in the neural network, and this layer is the layer other than the convolution layer or the pooling layer.

It is required to be noted that this step does not adopt the starting rule in which the starting layer is the top unfused convolution or pooling layer. If the starting layer is selected according to this starting rule, the starting layer may be restricted as either the convolution layer or the pooling layer. As such, the advantage that this embodiment is not limited by the positions and number of convolution layers or pooling layers in the neural network model does not exist.

In an application scenario, the starting layer may be an element-wise layer, which is also called an element-by-element layer. In this layer, each element of a vector is operated. For this type of operation, the shape of input data is the same as that of output data. The element-wise layer includes following types.

1. Elementary operations: vector addition, vector subtraction, vector multiplication, and the like.

2. Advanced operations: absolute value, square root, division, exponent, remainder, exponentiation, and the like.

3. Trigonometric function operations.

4. Rounding operations: ceil, round, floor, int, and the like.

5. Activation functions: sigmoid, tanh, ReLU, and the like.

In another application scenario, the starting layer may be an addpadding layer. The addpadding is used for not discarding information of original image and keeping a size of input data consistent with the original image by adding an element to the blank around the input data.

In another application scenario, the starting layer may be a self-defined layer. With the development of deep learning and the complexity of the neural network, public or standard operators are not enough, and more and more operators with self-defined operation rules are applied in the neural network. This embodiment may select the self-defined layer as the starting layer.

In another application scenario, the starting rule of the fusion policy of this embodiment enables the processing apparatus 203 to further judge whether the neural network includes a block structure. If the neural network does not include the block structure, it is represented that the neural network is a long-chain structure, and the processing apparatus 203 selects the top unfused layer in the neural network according to the starting rule. If the neural network includes the block structure, this embodiment performs the fusion preferentially by the block structure with reference to the rule 3. Then, the processing apparatus 203 judges whether the top layer in the block structure is the layer other than the convolution layer and the pooling layer. If the top layer in the block structure is the layer other than the convolution layer and the pooling layer, the processing apparatus 203 takes the top layer as the starting layer.

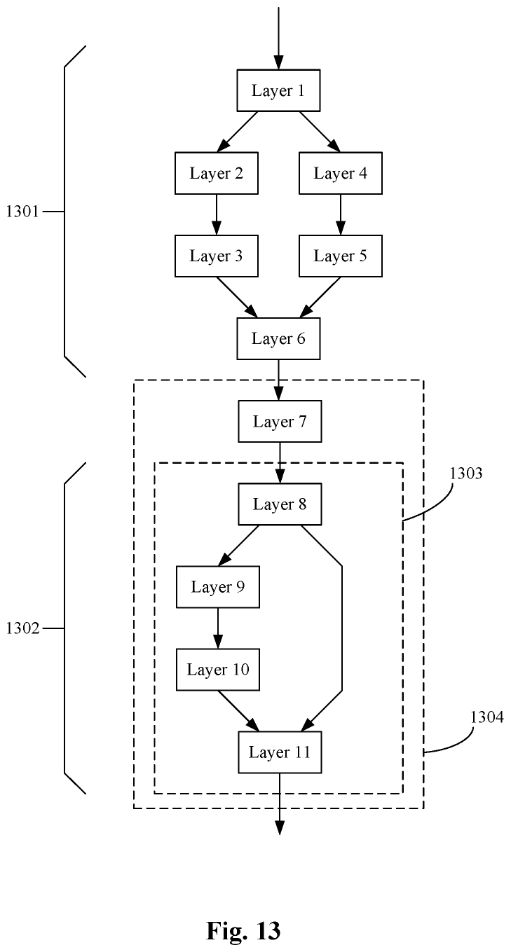

When the processing apparatus 203 judges that the top layer is one of the convolution layer and the pooling layer, the processing apparatus 203 may directly select the convolution layer or the pooling layer as the starting layer, or the processing apparatus 203 may forward select a layer closest to the top layer other than the convolution layer and the pooling layer as the starting layer. FIG. 13 shows a neural network model with a block structure. This exemplary neural network model includes a sub-network 1301 and a sub-network 1302. The sub-network 1301 includes layers 1 to 6. The sub-network 1302 includes layers 8 to 11. The sub-network 1301 and the sub-network 1302 are connected by layer 7. Assuming that the sub-network 1301 is fused, when fusing the sub-network 1302, according to the rules, the processing apparatus 203 judges whether the top layer (layer 8) of the sub-network 1302 is a layer other than a convolution layer and a pooling layer. If the top layer (layer 8) of the sub-network 1302 is the layer other than the convolution layer and the pooling layer, layer 8 is directly selected as a starting layer for fusion. If layer 8 is the convolution layer or the pooling layer, the processing apparatus 203 may also select layer 8 as the starting layer, or the processing apparatus 203 may forward select a layer closest to the top layer other than the convolution layer and the pooling layer as the starting layer. If a preceding layer closest to layer 8 is layer 7, layer 7 is not fused, and it is assumed that layer 7 is neither the convolution layer nor the pooling layer, and then the processing apparatus 203 selects layer 7 as the starting layer. If layer 7 is the convolution layer or the pooling layer, this embodiment may select layer 7 or layer 8 as the starting layer.

This embodiment preferentially fuses the whole block structure to improve fusion benefits. However, in a specific application scenario, the processing apparatus 203 is unable to forward select the layer closest to the top layer other than the convolution layer and the pooling layer as the starting layer. Taking the neural network model of FIG. 7 as an example, assuming that the sub-network 701 is fused, when fusing the sub network 702, if layer 7 is the convolution layer or the pooling layer, while in the case where the sub-network 701 is fused, the processing apparatus 203 is unable to forward select the layer closest to the top layer other than the convolution layer and the pooling layer as the starting layer. At this time, the processing apparatus 203 changes to backward select the layer (layer 8) closest to the top layer other than the convolution layer and the pooling layer as the starting layer. However, as such, the whole block structure may not be incorporated into the template fuse unit. Since fusion effect achieved by using layer 8 as the starting layer is not ideal, the processing apparatus 203 may also directly select layer 7 as the starting layer.

After the starting layer is selected, the step 1102 is then performed to create the template fuse unit based on the starting layer. The processing apparatus 203 may create the template fuse unit according to rules (rules 1 to 19) that are enumerated in the above embodiment. These rules are only examples. The present disclosure does not restrict the order in which the rules are performed or the fact that these rules are required to be considered simultaneously. Those skilled in the art may add or delete the rules in different application scenarios according to actual situations to implement a fusion policy that meets a current application scenario.

The step 1101 and the step 1102 correspond to the step 1201 where the template fuse unit is determined according to the fusion policy. Next, the compiler derives the shape of the template fuse unit (the step 1202), derives the address (the step 1203), and allocates the on-chip storage space (the step 1204). Finally, the executable instruction is generated by the linker (the step 1205).

In the step 1103, neural network computing is performed according to the template fuse unit created. The computing apparatus 201 performs the executable instruction to perform the neural network computing according to the template fuse unit.

The starting layer of this embodiment may be a layer other than the convolution layer and the pooling layer. Such a starting rule makes the creation of the template fuse unit more flexible. For different neural networks, the starting layer is appropriately selected to start the fusion, which is not limited by the positions and number of convolution layers or pooling layers in the neural network model, thereby adapting to various network models, making the fusion more comprehensive, and improving the whole benefit.

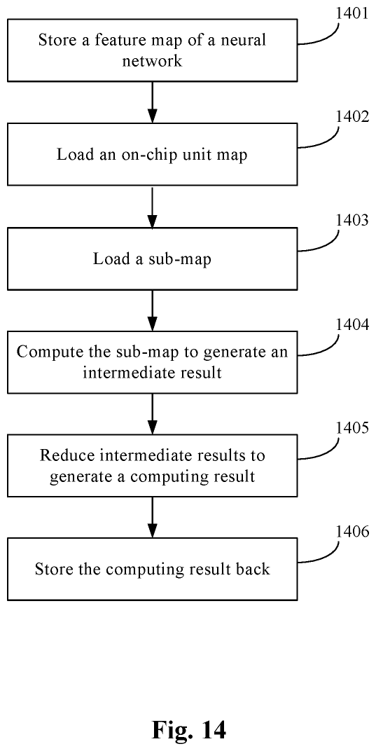

After generating the executable instruction, the computing apparatus 201 may infer the neural network by taking the template fuse unit as a unit according to the executable instruction. Another embodiment of the present disclosure shows a solution of computing the neural network based on the executable instruction. This solution also has the framework shown in FIGS. 1 to 4 and is a diagram used for computing the template fuse unit. This diagram implements a process shown in FIG. 14.

In a step 1401, a feature map of a neural network is stored. As described in the foregoing embodiment, the processing apparatus 203 fuses a plurality of layers of the neural network according to a fusion policy to generate a template fuse unit, and based on each rule, the processing apparatus 203 appropriately splits the feature map into an on-chip unit map.

More specifically, when the processing apparatus 203 determines the template fuse unit according to the fusion policy in the step 1201 of FIG. 12 and judges that the feature map is greater than available space of the SRAM 308, which refers to a large map mode, it is required to split the feature map to enable the feature map to be loaded into the SRAM 308 multiple times. The splitting method is to split in at least one of N, H, and W dimensions with specific granularity. In this embodiment, the specific granularity may be but is not limited to half. However, when the processing apparatus 203 judges that the feature map is not greater than the available space of the SRAM 308, which refers to a small map mode, the on-chip unit map may include a single feature map or a plurality of feature maps, depending on the available space of the SRAM 308 may load how many feature maps. Technical details of converting the feature map to the on-chip unit map have been described in the foregoing embodiment for the large map mode and the small map mode. Therefore, the following will not repeat those.

Feature maps for neural network computing are stored in the DRAM 204.

In a step 1402, the on-chip unit map is loaded. Since an executable instruction computes the neural network based on the template fuse unit, when the processing apparatus 203 performs the executable instruction, neural network computing is performed according to the template fuse unit, rather than according to layer-by-layer computing of each layer of the neural network. The executable instruction contains information about how to split the feature map into the on-chip unit map. In other words, the executable instruction contains address information of the on-chip unit map. The SRAM 308 loads the on-chip unit map from the appropriate address of the DRAM 204 via the GMDA 311 according to the address information.

In a step 1403, a sub-map is loaded. The NRAM 432 loads the sub-map via the MVDMA 434. Taking a case where one cluster 305 includes four processor cores 306 as an example, the on-chip unit map is split into four sub-maps. One processor core 306 in the cluster 305 splits the on-chip unit map into four sub-maps in at least one of N, H, and W dimensions with specific granularity. Then, the sub-maps are sent to the NRAM 432 of each processor core 306 via the MVDMA 434, respectively. In this embodiment, the specific granularity may be but is not limited to half.

In a step 1404, the sub-map is computed to generate a corresponding intermediate result. The operation unit 42 of each processor core 306 takes out the sub-map from the NRAM 431 for computing and saves the intermediate result back to the NRAM 431 after generating the intermediate result. It is required to be noted that since a sub-map assigned to each processor core 306 belongs to a different part of the on-chip unit map, each intermediate result also reflects a part of a computing result.

In a step 1405, intermediate results are reduced to generate a computing result corresponding to the on-chip unit map. Reduction refers to combining the intermediate results into the computing result, which is also the aforementioned output-dependent operation. The broadcast bus 309 sends an intermediate result of each processor core 306 to a next processor core 306. The processor core 306 computes an intermediate result of a previous processor core 306 and a corresponding intermediate result that the processor core 306 stores, so as to generate the computing result. The reduction may be implemented in a variety of ways, such as ring allreduce. The present disclosure does not limit a way of reduction.

Finally, a step 1406 is performed to store the computing result back. The SRAM 308 stores the computing result back to the DRAM 204 via the GDMA 311. These computing results are results of computing the on-chip unit map by the clusters. At this point, the computing apparatus 201 completes the computing of the on-chip unit map.

This embodiment computes the neural network based on the executable instruction. The executable instruction of this embodiment performs computing according to the template fuse unit, rather than each layer of the neural network. As such, on-chip and off-chip input/output consumption may be reduced, and computing efficiency may be improved.

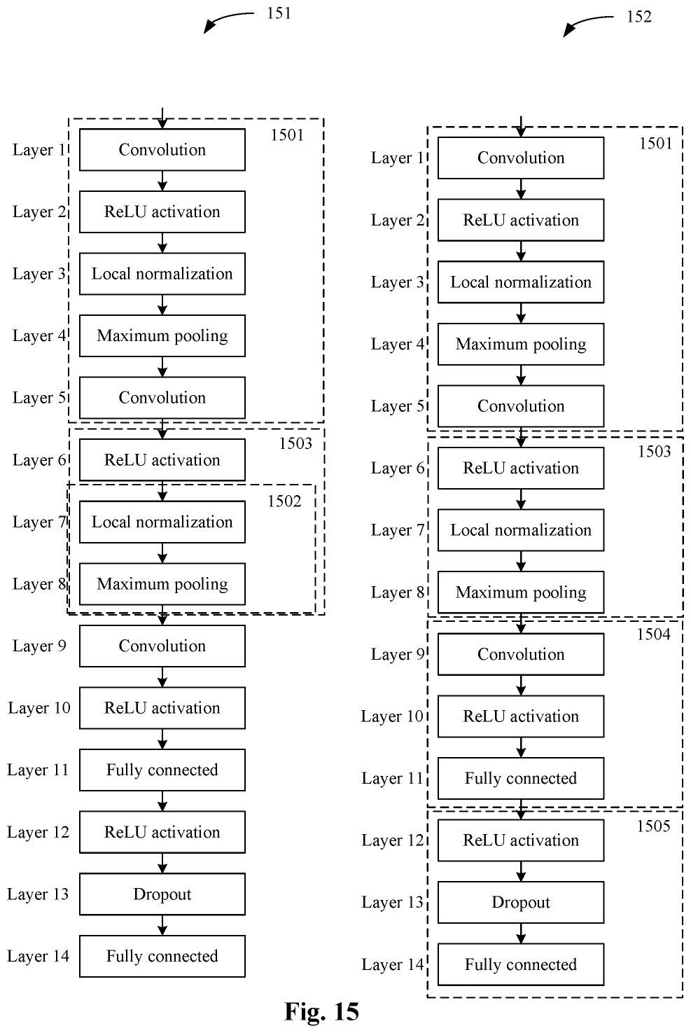

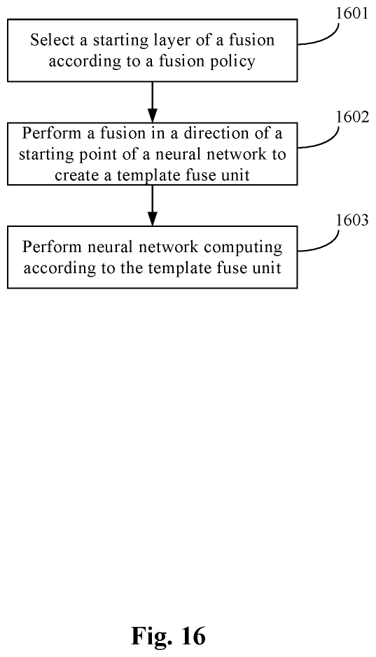

As mentioned in rule 2 of the aforementioned fusion policy, the present disclosure may choose to preferentially perform a forward fusion. The forward fusion refers to a fusion in an opposite direction of neural network inference from a starting layer. In other words, the fusion is performed in a direction of a starting point of the neural network. FIG. 15 shows an exemplary long-chain neural network, which has 14 layers totally. Another embodiment of the present disclosure shows a method of implementing a forward fusion of a neural network by using the framework of FIGS. 1-4. The neural network is illustratively the long-chain neural network shown in FIG. 15. The method is as shown in FIG. 16.

In a step 1601, a starting layer of a fusion is selected according to a fusion policy. First, referring to a neural network 151, the processing apparatus 203 selects the starting layer of the fusion according to the fusion policy. For the sake of explanation, it is assumed that layers 1 to 5 in FIG. 15 have been fused into a template fuse unit 1501. Moreover, one of rules of the fusion policy of this embodiment is that the starting layer is a top unfused convolution or pooling layer. In this step, when performing the fusion, the processing apparatus 203 judges which of unfused layers are convolution layers or pooling layers. As shown in the figure, layer 8 is a maximum pooling layer, layer 9 is a convolution layer, and therefore, the top unfused convolution or pooling layer is layer 8, and the processing apparatus 203 sets layer 8 as a starting layer of this fusion.

In a step 1602, the fusion is performed in a direction of a starting point of a neural network to create a template fuse unit. In this embodiment, layers in the template fuse unit should be continuous, and each layer should not fuse unfused layers over fused layers. In other words, layers in the template fuse unit should be continuous unfused layers. When layer 8 is the starting layer and the fusion is performed in the direction of the starting point of the neural network 151, layer 7 is incorporated into the template fuse unit, and the processing apparatus 203 judges whether layer 7 is an unfused layer. Since only layers 1 to 5 have been fused into the template fuse unit 1501, layer 7 is the unfused layer, and the processing apparatus 203 sets layer 7 (local normalization layer) to be fused with layer 8 (maximum pooling), which is a template fuse unit 1502.

When fusing, the processing apparatus 203 views a top layer in the template fuse unit 1502 as an input layer of the template fuse unit 1502. In other words, layer 7 is the input layer. Moreover, the processing apparatus 203 views a last layer in the template fuse unit 1502 as an output layer of the template fuse unit 1502. In other words, the starting layer, layer 8, is the output layer. The processing apparatus 203 performs a pyramid fusion based on the input layer and the output layer. More specifically, the template fuse unit 1502, based on an inverted pyramid data structure shown in FIG. 8, takes an input of layer 7 as an input of the template fuse unit 1502 and an output of layer 8 as an output of the template fuse unit 1502, and derives backward from output data to input data. Intermediate data between layer 7 and layer 8 is stored in the SRAM 308 and is not stored back to the DRAM 204. Under this principle, judgment is performed according to rules of the fusion policy mentioned in the above embodiment, so as to determine whether layer 7 plus layer 8 satisfies the rules and may be the template fuse unit.

Assuming that the template fuse unit 1502 satisfies all rules of the fusion policy, next, the processing apparatus 203 continues the fusion in the direction of the starting point of the neural network 151. In other words, the processing apparatus 203 intends to incorporate layer 6 (ReLU activation layer) into the template fuse unit, which is a template fuse unit 1503. The template fuse unit 1503 also has the inverted pyramid data structure shown in FIG. 8. An input of layer 6 is used as an input of the template fuse unit 1503, and an output of layer 8 is used as an output of the template fuse unit 1503. Both intermediate data between layer 6 and layer 7 and the intermediate data between layer 7 and layer 8 are stored in the SRAM 308 and are not stored back to the DRAM 204. The judgment is performed according to the rules of the fusion policy mentioned in the above embodiment, so as to determine whether layers 6 to 8 satisfy the rules and may be the template fuse unit.

Assuming that the template fuse unit 1503 also satisfies all rules of the fusion policy, next, the processing apparatus 203 continues the fusion in the direction of the starting point of the neural network 151. In other words, the processing apparatus 203 intends to incorporate layer 5 into the template fuse unit. The processing apparatus 203 judges whether a newly added layer has been fused. Since layer 5 has been fused into the template fuse unit 1501, the processing apparatus 203 does not incorporate layer 5. At this point, the fusion is stopped, and the template fuse unit at this stage is created, which is the template fuse unit 1503.

The whole neural network 151 is fused in the way described above. A neural network 152 shows a possible final fusion result. Originally, the whole neural network 152 includes 14 layers, which are 14 operators. After the fusion, the 14 layers become four self-defined layers, which are four self-defined operators, including the template fuse unit 1501, the template fuse unit 1503, a template fuse unit 1504, and a template fuse unit 1505.

Going back to FIG. 16, in a step 1603, neural network computing is performed according to the template fuse unit. In the neural network 152, the computing apparatus 201 performs the neural network computing according to four self-defined layers composed of the template fusion unit 1501, the template fusion unit 1503, the template fusion unit 1504, and the template fusion unit 1505. In other words, when performing the neural network computing, the computing apparatus 201 performs the aforementioned four self-defined layers to replace original 14 layers, thus achieving technical effects of reducing input/output overheads and improving resource benefits.

When computing the neural network, since the template fuse unit includes a plurality of layers, when computing by taking the template fuse unit as a unit, the present disclosure loads required weights from the DRAM 204 to the SRAM 308 at a time. Taking a case where one template fuse unit includes a first convolution layer and a second convolution layer as an example, when computing the template fuse unit, the processing apparatus 203 not only loads a weight of the first convolution layer into the SRAM 308, but also loads a weight of the second convolution layer into the SRAM 308. More specifically, when the processor cores 306 computes the first convolution layer, the weight of the second convolution layer has already been stored in the SRAM 308. Once the first convolution layer is computed, the weight of the second convolution layer may be loaded from the SRAM 308 to the WRAM 432 immediately, so as to improve the speed of loading the weight.

Not only that, the WRAM 432 may also pre-load the weight. If the WRAM 432 is large enough, the weight of the first convolution layer and the weight of the second convolution layer may be loaded from the SRAM 308 to the WRAM 432 at a time. When the first convolution layer is computed, the weight of the second convolution layer is not required to be loaded from the SRAM 308 to the WRAM 432, and the operation unit 42 directly reads the weight of the second convolution layer from the WRAM 432 for computing. As such, time of weight loading may be further reduced, and the overall running speed may be further improved.

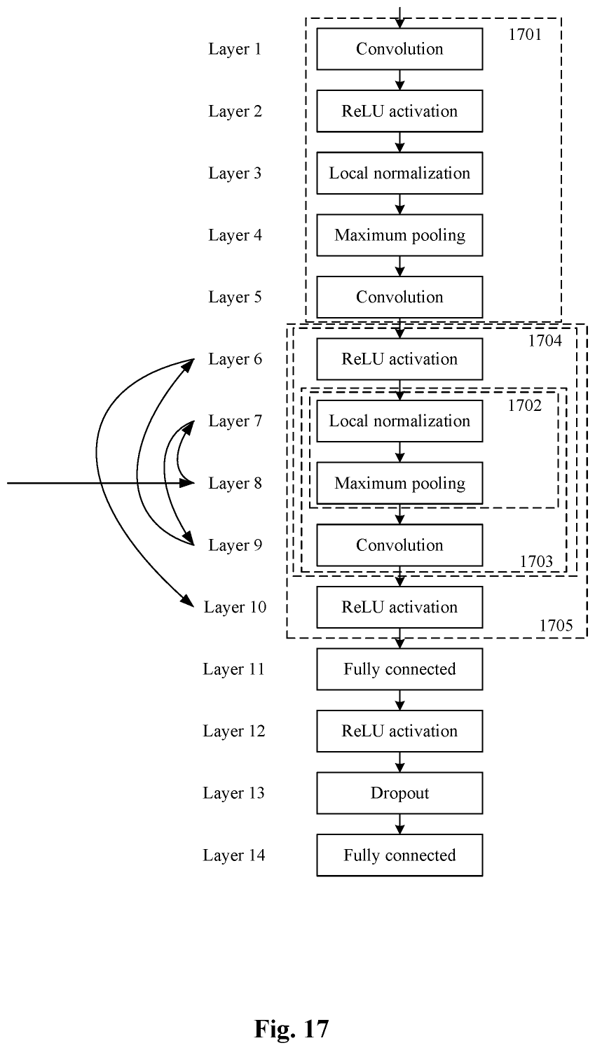

Another embodiment of the present disclosure shows a method of implementing a bidirectional fusion of a neural network by using the framework of FIGS. 1-4. The neural network also takes the long-chain neural network in FIG. 15 as an example and is also shown in FIG. 17 for illustration.

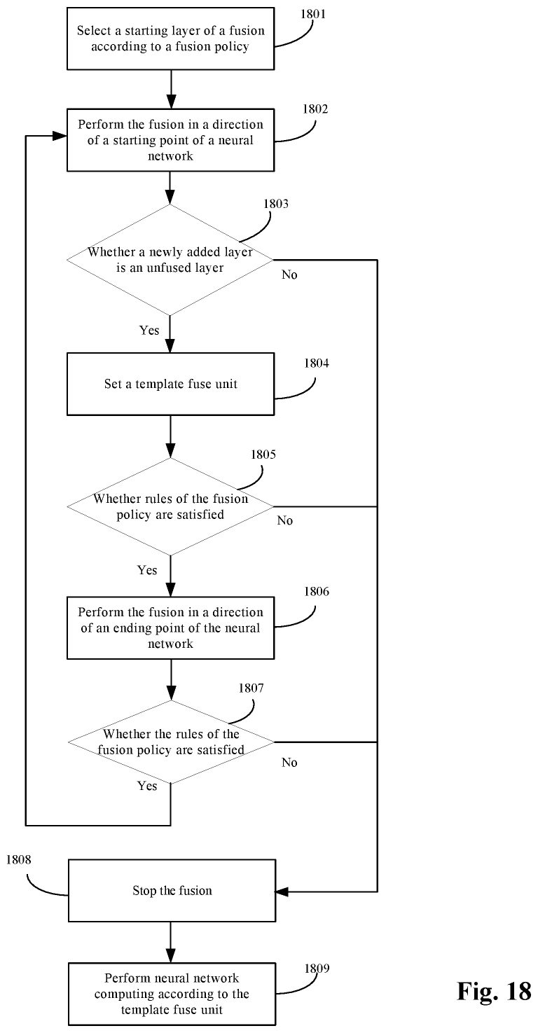

The bidirectional fusion means that the fusion may be performed either forward or backward. The method is as shown in FIG. 18. According to a fusion policy, the fusion may also be performed forward and backward to create a template fuse unit. Then, neural network computing is performed according to the template fuse unit. Similarly, it is assumed that layers 1 to 5 in FIG. 17 have been fused into a template fuse unit 1701. Moreover, a starting rule of the fusion policy of this embodiment is that a starting layer is a top unfused convolution or pooling layer.

In a step 1801, the processing apparatus 203 selects a starting layer of a fusion according to a fusion policy. The processing apparatus 203 judges that the top unfused convolution or pooling layer is a maximum pooling layer of layer 8, and therefore, the processing apparatus 203 sets layer 8 as a starting layer of this fusion.

In a step 1802, the fusion is performed in a direction of a starting point of a neural network. The processing apparatus 203 performs the fusion forward and incorporates layer 7 into the template fuse unit. Layer 7 becomes a newly added layer.

In a step 1803, the processing apparatus 203 judges whether a newly added layer is an unfused layer. If layer 7 is the unfused layer, a step 1804 is performed, and the processing apparatus 203 sets layer 7 and layer 8 as a template fuse unit 1702.

Next, a step 1805 is performed, and the processing apparatus 203 judges whether the template fuse unit 1702 complies with rules of the fusion policy. When fusing, the processing apparatus 203 views a top layer in the template fuse unit 1702 as an input layer of the template fuse unit 1702. In other words, layer 7 is the input layer. Moreover, the processing apparatus 203 views the starting layer as an output layer of the template fuse unit 1702. In other words, layer 8 is the output layer. The processing apparatus 203 performs a pyramid fusion based on the input layer and the output layer.

If the template fuse unit 1702 complies with the rules of the fusion policy, a step 1806 is performed, and the processing apparatus 203 performs a fusion in a direction of an ending point of the neural network from the starting layer. In other words, the fusion starts from layer 8, and layer 7 is fused first. In this step, the fusion jumps backward to fuse layer 9, so as to form a template fuse unit 1703. This kind of jumping forward and backward to fuse is called a jump fusion.

In a step 1807, the processing apparatus 203 judges whether the template fuse unit 1703 complies with the rules of the fusion policy. When fusing, the processing apparatus 203 views a top layer of continuous layers in the template fuse unit 1703 as an input layer of the template fuse unit 1703. In other words, layer 7 is the input layer. While, the processing apparatus 203 views a last layer of backward jump as an output layer of the template fuse unit 1703. In other words, layer 9 is the output layer. The processing apparatus 203 performs a pyramid fusion based on the input layer and the output layer.

If the template fuse unit 1703 complies with the rules of the fusion policy, this process goes back to the step 1802 to continue to perform the fusion in the direction of the starting point of the neural network. Then, the processing apparatus 203 incorporates layer 6 into the template fuse unit. In the step 1803, the processing apparatus 203 judges whether the newly added layer is the unfused layer. If layer 6 is the unfused layer, the step 1804 is performed, and the processing apparatus 203 sets layer 6 and layer 9 as a template fuse unit 1704.

Next, the step 1805 is performed, and the processing apparatus 203 judges whether the template fuse unit 1704 complies with the rules of the fusion policy. When fusing, the processing apparatus 203 views a top layer in the template fuse unit 1704 as an input layer of the template fuse unit 1704. In other words, layer 6 is the input layer. Moreover, the processing apparatus 203 views a last layer of backward jump as an output layer of the template fuse unit 1704. In other words, layer 9 is the output layer. The processing apparatus 203 performs a pyramid fusion based on the input layer and the output layer.

If the template fuse unit 1704 complies with the rules of the fusion policy, the step 1806 is performed, and the processing apparatus 203 performs the fusion in the direction of the ending point of the neural network. At this point, the jump fusion of layer 10 is performed, so as to form a template fuse unit 1705. In the step 1807, the processing apparatus 203 judges whether the template fuse unit 1705 complies with the rules of the fusion policy. When fusing, the processing apparatus 203 views a top layer of continuous layers in the template fuse unit 1705 as an input layer of the template fuse unit 1705. In other words, layer 6 is the input layer. While, the processing apparatus 203 views a last layer of backward jump as an output layer of the template fuse unit 1705. In other words, layer 10 is the output layer. The processing apparatus 203 performs a pyramid fusion based on the input layer and the output layer.

If the template fuse unit 1704 complies with the rules of the fusion policy, this process goes back to the step 1802 to continue to perform the fusion in the direction of the starting point of the neural network. Then, the processing apparatus 203 incorporates layer 5 into the template fuse unit. In the step 1803, the processing apparatus 203 judges whether layer 5 is the unfused layer. Since layer 5 has been fused into the template fuse unit 1701, a step 1808 is performed, and the processing apparatus 203 stops the fusion. In the step 1805 and the step 1807, when the processing apparatus 203 judges that the template fuse unit does not comply with the rules of the fusion policy, the step 1808 is also performed, and the processing apparatus 203 stops the fusion. At this point, the processing apparatus 203 creates the template fuse unit.

Finally, a step 1809 is performed, and the computing apparatus 201 performs neural network computing according to the template fuse unit created.

In another application scenario, if the processing apparatus 203 judges that the newly added layer has been fused in the step 1803, the processing apparatus 203 may jump to perform the fusion in the direction of the ending point of the neural network. For example, when the processing apparatus 203 judges that layer 5 has been fused, the step 1806 is directly performed, and the processing apparatus 203 performs the fusion in the direction of the ending point of the neural network. At this time, the jump fusion of layer 11 is performed. In other words, a new template fuse unit includes layers 6 to 11, and the fusion is performed backward until the fusion policy is no longer satisfied.

In another application scenario, the jump fusion of this embodiment may be performed by fusing backward first and then fusing forward, and the jump may be performed in order. Similarly, taking a case where layer 8 in FIG. 17 is the starting layer as an example, the processing apparatus 203 forward fuses layer 9 first. Next, the processing apparatus 203 jumps forward to fuse layer 7. Then, the processing apparatus 203 jumps backward to fuse layer 10, and so on. The present disclosure does not limit the order in which forward and backward jump fusions are performed.

This embodiment explains the operation mode of the jump fusion. It may be understood that the aforementioned jump fusion jumps forward or backward once as one layer is fused every time, as shown by arrows on the left side of FIG. 17. Those skilled in the art may adjust the way of jumping easily within the scope of the present disclosure. Jump is performed once as n layers are fused every time, where n is a natural number. For example, the jump is performed forward or backward once as two layers are fused every time, or the jump is performed forward or backward once as three layers are fused every time. Such adjustments are covered by the scope of disclosure of the present disclosure and also by the scope of protection of the present disclosure.

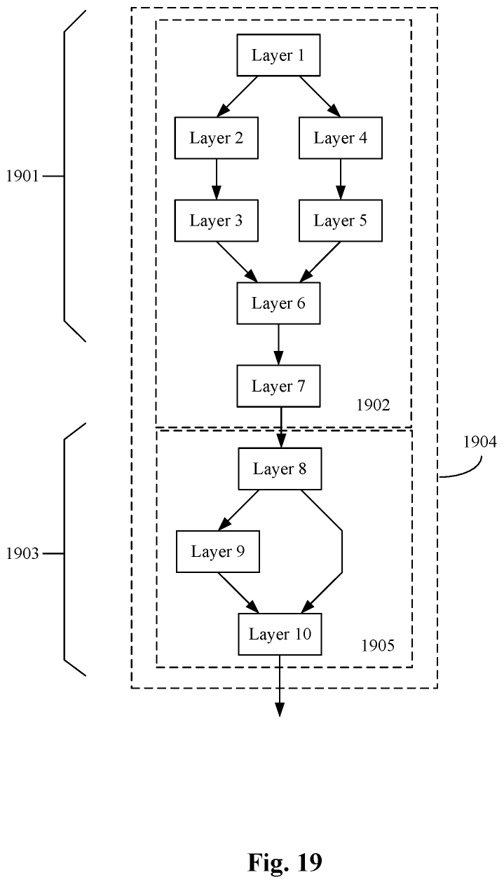

Another embodiment of the present disclosure shows a method of implementing a bidirectional fusion of a neural network by using the framework of FIGS. 1-4. The neural network illustratively has a block structure shown in FIG. 19. A starting rule of a fusion policy of this embodiment is also that a starting layer is a top unfused convolution or pooling layer. A jump fusion is performed in a direction of a starting point of the neural network and in a direction of an ending point of the neural network from the starting layer to create a template fuse unit. Then, neural network computing is performed according to the template fuse unit. Additionally, since this neural network is a block structure, one of rules of the fusion policy of this embodiment is to fuse by taking the block structure as a unit. The following further explains how the template fuse unit is determined.

First, the processing apparatus 203 selects the starting layer of the fusion according to the fusion policy. Moreover, the fusion is performed in the direction of the starting point of the neural network from the starting layer. Assuming that the top unfused convolution or pooling layer is layer 7, therefore, the processing apparatus 203 sets layer 7 as a starting layer of this fusion and forward incorporates layer 6 into the template fuse unit. Although layer 6 is an unfused layer and may be fused, the processing apparatus 203 judges that layer 6 belongs to a block structure 1901. According to the fusion policy, the processing apparatus 203 is required to perform the fusion by taking the block structure 1901 as a unit. Therefore, the processing apparatus 203 incorporates layers 1 to 6 at a time, which forms a template fuse unit 1902.

Next, the processing apparatus 203 judges whether the template fuse unit 1902 complies with other rules of the fusion policy. When fusing, the processing apparatus 203 views layer 1 as an input layer of the template fuse unit 1902 and layer 7 as an output layer of the template fuse unit 1902. The processing apparatus 203 performs a pyramid fusion based on the input layer and the output layer. This embodiment selects appropriate rules to form the fusion policy with reference to rules 1 to 19, such as rule 5: including at least two main layers, rule 6: including a continuous structure in which the main layer, the main layer, and a non-main layer are successively adjacent, and rule 7: including a continuous structure in which a scalar computing layer and a vector computing layer are adjacent, and the like.

If the template fuse unit 1902 complies with the rules of the fusion policy, next, the processing apparatus 203 performs the fusion in the direction of the ending point of the neural network. In other words, the processing apparatus 203 fuses layer 8. However, since layer 8 has two outputs, which makes the template fuse unit become a multi-branch output, layer 8 does not comply with rule 4. Moreover, layer 8 belongs to a block structure 1903. The processing apparatus 203 fuses the whole block structure 1903 to form the template fuse unit 1904. Next, the processing apparatus 203 judges whether the template fuse unit 1904 complies with the rules of the fusion policy. If the template fuse unit 1904 complies with the rules of the fusion policy, the template fuse unit 2804 is a final template fuse unit. The computing apparatus 201 performs the neural network computing according to the template fuse unit 1904. If the template fuse unit 1904 does not comply with the rules of the fusion policy, it is represented that hardware conditions of the computing apparatus 201 are insufficient to support to perform the template fuse unit 2804 at a time. At this time, the processing apparatus 203 stops the fusion and creates one template fuse unit thereof, which is the template fuse unit 1902.

The processing apparatus 203 continues to try to fuse the block structure 1903 to form another template fuse unit 1905. Assuming that the template fuse unit 1905 complies with the fusion policy, the processing apparatus 203 then creates another template fuse unit.

Finally, the computing apparatus 201 performs the neural network computing according to two created template fuse units, which are the template fuse unit 1902 and the template fuse unit 1905. Compared to 10 layers of computing, input/output consumption is greatly reduced.

Another embodiment of the present disclosure shows a solution of implementing forward, backward, bidirectional, and jump fusions of the neural network by using the framework of FIGS. 1-4. The solution of implementing forward, backward, bidirectional, and jump fusions of the neural network has been described in the aforementioned plurality of embodiments and will not be repeated separately. The fusion policy of this embodiment has a variety of fusion flexibility. For a same neural network, advantages and disadvantages of various template fuse unit solutions of forward, backward, bidirectional, and jump fusions may be evaluated respectively, and then the best solution is selected as the template fuse unit. In this embodiment, the best solution may be that the number of template fuse units is the least, main layers are fused most, the number of unfused layers is the least, or on-chip storage space occupied by the unfused layers is the least. Since this embodiment may accept a variety of fusion methods and select the best one as the template fuse unit, this embodiment may make full use of hardware environment of the computing apparatus 201. Compared with the aforementioned embodiment, this embodiment may further save input/output losses and improve computing efficiency.

Another embodiment of the present disclosure shows a computer readable storage medium, on which computer program codes for dynamically fusing a neural network according to a fusion policy are stored. When the computer program codes are run by a processor, methods described in FIG. 10, FIG. 11, FIG. 12, FIG. 14, FIG. 16, and FIG. 18 are performed.

The present disclosure relates to both a forward fusion solution and a forward and backward jump fusion and flexibly provides more fusion methods, which may create the best template fuse unit for different neural network models and reduce input/output overheads.

By setting the fusion policy, the present disclosure dynamically determines the template fuse unit, fuses a plurality of layers in the neural network to form a new self-defined layer, and loads data required for computing the template fuse unit at a time to reduce input/output overheads.

According to different application scenarios, an electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with hardware information of the terminal device and/or the edge device. As such, according to the hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the direct or indirect coupling relates to a communication connection using an interface, where the communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the solution described in embodiments of the present disclosure. Additionally, in some scenarios, a plurality of units in the embodiments of the present disclosure may be integrated into one unit, or each of the units may be physically separated.

In some implementation scenarios, the integrated unit may be implemented in the form of a software program unit. If the integrated unit is implemented in the form of the software program unit and sold or used as an independent product, the integrated unit may be stored in a computer-readable memory. Based on this, when the solution of the present disclosure is embodied in the form of a software product (such as a computer-readable storage medium), the software product may be stored in a memory. The software product may include several instructions used to enable a computer device (which may be a personal computer, a server, or a network device, and the like) to perform part or all of steps of the method of the embodiments of the present disclosure. The memory includes but is not limited to an USB, a flash disk, a read only memory (ROM), a random access memory (RAM), a mobile hard disk, a magnetic disk, or an optical disc, and other media that may store a program code.

In some other implementation scenarios, the integrated unit may be implemented in the form of hardware. The hardware may be a specific hardware circuit, which may include a digital circuit and/or an analog circuit. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a central processing unit (CPU), a graphics processing unit (GPU), a field-programmable gate array (FPGA), a digital signal processor (DSP), and an application-specific integrated circuit (ASIC), and the like. Further, the storage unit or the storage apparatus may be any appropriate storage medium (including a magnetic storage medium or a magneto-optical storage medium, and the like), such as a resistive random access memory (RRAM), a dynamic random access memory (DRAM), a static random access memory (SRAM), an enhanced dynamic random access memory (EDRAM), a high bandwidth memory (HBM), a hybrid memory cube (HMC), the ROM, and the RAM, and the like.

The foregoing may be better understood according to following articles:

2020110438889 Article A1. An integrated circuit apparatus for fusing a neural network, including a processing apparatus configured to select a starting layer according to a fusion policy and create a template fuse unit; and a computing apparatus configured to perform neural network computing according to the template fuse unit, where the starting layer is a layer other than a convolution layer and a pooling layer.

Article A2. The integrated circuit apparatus of article A1, where the starting layer is an element-wise layer.

Article A3. The integrated circuit apparatus of article A2, where the starting layer is one of an elementary operation layer, an advanced operation layer, a trigonometric function operation layer, a rounding operation layer, and an activation layer.

Article A4. The integrated circuit apparatus of article A1, where the starting layer is an addpadding layer.

Article A5. The integrated circuit apparatus of article A1, where the starting layer is a self-defined layer.

Article A6. The integrated circuit apparatus of article A1, where the fusion policy is that the starting layer is a top unfused layer in the neural network.

Article A7. The integrated circuit apparatus of article A1, where the fusion policy is that, when the neural network includes a block structure, the processing apparatus judges whether a top layer in the block structure is the layer other than the convolution layer and the pooling layer; if the top layer in the block structure is the layer other than the convolution layer and the pooling layer, the processing apparatus selects the top layer as the starting layer, and the template fuse unit includes the block structure.

Article A8. The integrated circuit apparatus of article A7, where, when the processing apparatus judges that the top layer is one of the convolution layer and the pooling layer, the processing apparatus forward selects a layer closest to the top layer other than the convolution layer and the pooling layer as the starting layer, and the template fuse unit includes the block structure.

Article A9. The integrated circuit apparatus of article A7, where, when the processing apparatus judges that the top layer is one of the convolution layer and the pooling layer, the processing apparatus backward selects a layer closest to the top layer other than the convolution layer and the pooling layer as the starting layer.

Article A10. The integrated circuit apparatus of article A1, where the computing apparatus includes a plurality of clusters, each cluster includes a shared storage unit, and the processing apparatus judges whether a size of a feature map is greater than available space of the shared storage unit; if the size of the feature map is greater than the available space of the shared storage unit, the processing apparatus splits the feature map into an on-chip unit map, and a size of the on-chip unit map is not greater than the available space of the shared storage unit.

Article A11. The integrated circuit apparatus of article A10, where the feature map includes N, H, W, and C dimensions, and the processing apparatus splits the feature map in one of the N, H, W, and C dimensions with specific granularity.

Article A12. The integrated circuit apparatus of article A11, where the C dimension is an output channel parameter.

Article A13. The integrated circuit apparatus of article A12, where each cluster further includes a plurality of processor cores, each processor core includes a weight storage unit, the fusion policy is that a weight involved in the on-chip unit map divided by the number of the processor cores is not greater than available space of the weight storage unit, and when the processing apparatus judges that the fusion policy is not satisfied, the processing apparatus reduces the number of feature maps.

Article A14. The integrated circuit apparatus of article A10, where the fusion policy is that a sum of redundancy generated by splitting the feature map into the on-chip unit map does not exceed a percentage threshold, and when the processing apparatus judges that the fusion policy is not satisfied, the processing apparatus stops the fusion.

Article A15. The integrated circuit apparatus of article A14, where a rule is

$$\frac{( {size}_{TFU} - {size}_{ori} )}{{size}_{ori}} \times 100 \% \geq percentage threshold ,$$

where

size_{TFU} is the sum of redundancy, and sizeₒᵣᵢ is the amount of data of the on-chip unit map.

Article A16. The integrated circuit apparatus of article A10, where, when the processing apparatus judges that the size of the feature map is not greater than the available space of the shared storage unit, the processing apparatus further analyzes how many feature maps the available space of the shared storage unit is able to accommodate, and the collection of all input feature maps that are able to be accommodated is the on-chip unit map.

Article A17. The integrated circuit apparatus of article A16, where the fusion policy is that, if storage space of the on-chip unit map and storage space of a computing result of the on-chip unit map are unable to be reused, a sum of the storage space of the on-chip unit map and the storage space of the computing result of the on-chip unit map is less than the available space of the shared storage unit, and when the processing apparatus judges that the fusion policy is not satisfied, the processing apparatus reduces the number of input feature maps in the on-chip unit map until the fusion policy is satisfied.

Article A18. The integrated circuit apparatus of article A16, where the fusion policy is that, if storage space of the on-chip unit map and storage space of a computing result of the on-chip unit map are able to be reused, the larger of the storage space of the on-chip unit map and the storage space of the computing result of the on-chip unit map is less than the available space of the shared storage unit, and when the processing apparatus judges that the fusion policy is not satisfied, the processing apparatus reduces the number of input feature maps in the on-chip unit map until the fusion policy is satisfied.

Article A19. The integrated circuit apparatus of article A16, where the cluster further includes processor cores and a memory core, the memory core splits the on-chip unit map into a sub-map, one of the processor cores computes the sub-map, and the shared storage unit includes cache space.

Article A20. The integrated circuit apparatus of article A19, where the fusion policy is that a sum of a weight of the sub-map, the on-chip unit map, and the cache space is not greater than the available space of the shared storage unit, and when the processing apparatus judges that the fusion policy is not satisfied, the processing apparatus reduces the number of input feature maps in the on-chip unit map until the fusion policy is satisfied.

Article A21. The integrated circuit apparatus of article A19, where the fusion policy is that a sum of the sub-map, the weight of the sub-map, and the cache space is not greater than the available space of the shared storage unit, and when the processing apparatus judges that the fusion policy is not satisfied, the processing apparatus reduces the number of input feature maps in the on-chip unit map until the fusion policy is satisfied.

Article A22. A board card, including the integrated circuit apparatus of any one of articles A1-A21.

Article A23. A method for fusing a neural network, including: selecting a starting layer according to a fusion policy; creating a template fuse unit based on the starting layer; and performing neural network computing according to the template fuse unit, where the starting layer is a layer other than a convolution layer and a pooling layer.

Article A24. The method of article A23, where a step of selecting includes: judging whether the neural network includes a block structure; judging whether a top layer in the block structure is the layer other than the convolution layer and the pooling layer if the neural network includes the block structure; using the top layer as the starting layer if the top layer in the block structure is the layer other than the convolution layer and the pooling layer, where the template fuse unit includes the block structure.

Article A25. A computer readable storage medium, on which computer program codes for fusing a neural network are stored, where, when the computer program codes are run by a processing apparatus, the method of article A23 or article A24 is performed. 2020110438889

2020110439025 Article B1. An integrated circuit apparatus for dynamically fusing a neural network according to a fusion policy, including:

a processing apparatus configured to:

select a starting layer of a template fuse unit according to a starting rule of the fusion policy; and

perform a fusion based on the starting layer and check rules of the fusion policy to create the template fuse unit; and

a computing apparatus configured to perform neural network computing according to the template fuse unit.

Article B2. The integrated circuit apparatus of article B1, where the starting rule is that the starting layer is a top unfused layer in the neural network.

Article B3. The integrated circuit apparatus of article B1, where the starting rule is that the starting layer is a top unfused convolution or pooling layer.

Article B4. The integrated circuit apparatus of article B3, where the fusion policy is to forward fuse a previous unfused layer from the convolution or pooling layer.

Article B5. The integrated circuit apparatus of article B2 or article B3, where the fusion policy is to backward fuse from the convolution or pooling layer.

Article B6. The integrated circuit apparatus of article B1, where the fusion policy is to add and delete the template fuse unit by taking the block structure as a unit when the neural network is a block structure.

Article B7. The integrated circuit apparatus of article B1, where the fusion policy is to add and delete the template fuse unit by taking a layer as a unit when the neural network is a long-chain structure.

Article B8. The integrated circuit apparatus of article B1, where the fusion policy is that an output of the template fuse unit is a single-branch output, and when the processing apparatus judges that the fusion policy is not satisfied, the processing apparatus adds and deletes the template fuse unit until the fusion policy is satisfied.

Article B9. The integrated circuit apparatus of article B1, where the neural network includes a plurality of main layers; a main layer is one of matrix multiplication, pooling, and convolution; a rule of the fusion policy is that the template fuse unit includes at least two main layers; and when the processing apparatus judges that the fusion policy is not satisfied, the processing apparatus adjusts the template fuse unit until the fusion policy is satisfied.

Article B10. The integrated circuit apparatus of article B1, where the neural network includes a plurality of main layers; a main layer is one of matrix multiplication, pooling, and convolution; the fusion policy is that the template fuse unit includes a continuous structure in which the main layer, the main layer, and a non-main layer are successively adjacent; and when the processing apparatus judges that the fusion policy is not satisfied, the processing apparatus adjusts the template fuse unit until the fusion policy is satisfied.

Article B11. The integrated circuit apparatus of article B10, where the structure is a single branch.

Article B12. The integrated circuit apparatus of article B1, where the fusion policy is that the template fuse unit includes a continuous structure in which a scalar computing layer and a vector computing layer are successively adjacent, and when the processing apparatus judges that the fusion policy is not satisfied, the processing apparatus adjusts the template fuse unit until the fusion policy is satisfied, where

the scalar computing layer includes one of an addition layer, a subtraction layer, and a multiplication layer, and the vector computing layer includes one of an activation layer, a batch normalization layer, and a scaling layer.

Article B13. The integrated circuit apparatus of article B1, where the fusion policy is that a weight of a convolution layer of the template fuse unit is not an output of any layer of the neural network, and when the processing apparatus judges that the fusion policy is not satisfied, the processing apparatus removes the convolution layer from the template fuse unit.

Article B14. The integrated circuit apparatus of article B1, where the fusion policy is that a weight of a convolution layer of the template fuse unit is not shared with any layer of the neural network, and when the processing apparatus judges that the fusion policy is not satisfied, the processing apparatus removes the convolution layer from the template fuse unit.

Article B15. The integrated circuit apparatus of article B1, where the computing apparatus includes a plurality of clusters; each cluster includes a shared storage unit; the processing apparatus judges whether storage space required by a feature map is greater than available space of the shared storage unit; if the storage space required by the feature map is greater than the available space of the shared storage unit, the processing apparatus splits the feature map into an on-chip unit map; and storage space required by the on-chip unit map is not greater than the available space of the shared storage unit.

Article B16. The integrated circuit apparatus of article B15, where the feature map includes N, H, W, and C dimensions, and the processing apparatus splits the feature map in one of the N, H, W, and C dimensions with specific granularity.

Article B17. The integrated circuit apparatus of article B16, where the C dimension is an output channel parameter.

Article B18. The integrated circuit apparatus of article B17, where each cluster further includes a plurality of processor cores; each processor core includes a weight storage unit; the fusion policy is that storage space required by a weight involved in the on-chip unit map divided by the number of the processor cores is not greater than available space of the weight storage unit; and when the processing apparatus judges that the fusion policy is not satisfied, the processing apparatus reduces a size of the on-chip unit map.

Article B19. The integrated circuit apparatus of article B15, where the fusion policy is that a sum of redundancy generated by splitting the feature map into the on-chip unit map does not exceed a percentage threshold, and when the processing apparatus judges that the fusion policy is not satisfied, the processing apparatus stops the fusion.

Article B20. The integrated circuit apparatus of article B19, where a rule is

$$\frac{( {size}_{TFU} - {size}_{ori} )}{{size}_{ori}} \times 100 \% \geq percentage threshold ,$$

where

size_{TFU} is the sum of redundancy, and sizeₒᵣᵢ is the amount of data of the on-chip unit map.

Article B21. The integrated circuit apparatus of article B15, where, when the processing apparatus judges that the storage space required by the feature map is not greater than the available space of the shared storage unit, the processing apparatus further analyzes how many feature maps the available space of the shared storage unit is able to accommodate, and the collection of all feature maps that are able to be accommodated is the on-chip unit map.

Article B22. The integrated circuit apparatus of article B21, where the fusion policy is that, if storage space of the on-chip unit map and storage space of a computing result of the on-chip unit map are unable to be reused, a sum of the storage space of the on-chip unit map and the storage space of the computing result of the on-chip unit map is less than the available space of the shared storage unit, and when the processing apparatus judges that the fusion policy is not satisfied, the processing apparatus reduces the number of feature maps in the on-chip unit map until the fusion policy is satisfied.

Article B23. The integrated circuit apparatus of article B21, where the fusion policy is that, if storage space of the on-chip unit map and storage space of a computing result of the on-chip unit map are able to be reused, the larger of the storage space of the on-chip unit map and the storage space of the computing result of the on-chip unit map is less than the available space of the shared storage unit, and when the processing apparatus judges that the fusion policy is not satisfied, the processing apparatus reduces the number of feature maps in the on-chip unit map until the fusion policy is satisfied.

Article B24. The integrated circuit apparatus of article B21, where the cluster further includes processor cores and a memory core; the memory core splits the on-chip unit map into a sub-map; one of the processor cores computes the sub-map; and the shared storage unit includes cache space.

Article B25. The integrated circuit apparatus of article B24, where the fusion policy is that a sum of storage space required by a weight of the sub-map, storage space required by the on-chip unit map, and the cache space is not greater than the available space of the shared storage unit, and when the processing apparatus judges that the fusion policy is not satisfied, the processing apparatus reduces the number of feature maps in the on-chip unit map until the fusion policy is satisfied.

Article B26. The integrated circuit apparatus of article B24, where the fusion policy is that a sum of storage space required by the sub-map, storage space required by a weight of the sub-map, and the cache space is not greater than the available space of the shared storage unit, and when the processing apparatus judges that the fusion policy is not satisfied, the processing apparatus reduces the number of feature maps in the on-chip unit map until the fusion policy is satisfied.

Article B27. The integrated circuit apparatus of article B24, where the processor core includes an operation unit, which is configured to compute the sub-map to generate an intermediate result; the fusion policy is that a sum of storage space required by the intermediate result, storage space required by a weight of a next sub-map, and the cache space is not greater than the available space of the shared storage unit; and when the processing apparatus judges that the fusion policy is not satisfied, the processing apparatus reduces the number of feature maps in the on-chip unit map until the fusion policy is satisfied.

Article B28. The integrated circuit apparatus of article B24, where each cluster further includes a plurality of processor cores; each processor core includes a weight storage unit; the fusion policy is that a sum of storage space required by a weight of the sub-map and storage space required by a weight of a next sub-map is not greater than available space of the weight storage unit; and when the processing apparatus judges that the fusion policy is not satisfied, the processing apparatus reduces the number of feature maps in the on-chip unit map until the fusion policy is satisfied.

Article B29. The integrated circuit apparatus of article B24, where each cluster further includes a memory core and a plurality of processor cores; each processor core includes a neuron storage unit; the feature map includes N, H, W dimensions; the fusion policy is that storage space required by the sub-map is not greater than available space of the neuron storage unit; and when the processing apparatus judges that the fusion policy is not satisfied, the memory core performs splitting in one of the N, H, and W dimensions with specific granularity until the fusion policy is satisfied.

Article B30. The integrated circuit apparatus of article B24, where a rule of the fusion policy is that the number of feature maps included in the on-chip unit map is not greater than a feature map threshold, and when the processing apparatus judges that the rule is not satisfied, the processing apparatus reduces the number of feature maps.

Article B31. The integrated circuit apparatus of article B24, where the template fuse unit includes a convolution or pooling layer; the fusion policy is that a sum of difference values between side lengths of a kernel of the convolution or pooling layer and a stride of the kernel of the convolution or pooling layer is not greater than a redundancy threshold; and when the processing apparatus judges that the fusion policy is not satisfied, the processing apparatus adjusts the template fuse unit until the fusion policy is satisfied.

Article B32. The integrated circuit apparatus of article B31, where the template fuse unit is a single branch.

Article B33. A board card, including the integrated circuit apparatus of any one of articles B1-B32.

Article B34. A method for dynamically fusing a neural network according to a fusion policy, including:

selecting a starting layer of a template fuse unit according to a starting rule of the fusion policy;

performing a fusion based on the starting layer and checking rules of the fusion policy to create the template fuse unit; and

performing neural network computing according to the template fuse unit created.

Article B35. A computer readable storage medium, on which computer program codes for dynamically fusing a neural network according to a fusion policy are stored, where, when the computer program codes are run by a processing apparatus, the method of article B34 is performed. 2020110439025

2020110439059 Article C1. An integrated circuit apparatus for fusing each layer of a neural network into a template fuse unit according to a feature map, including:

a computing apparatus, which includes a plurality of clusters, where each cluster includes a shared storage unit; and

a processing apparatus configured to:
judge whether storage space required by the feature map is greater than available space of the shared storage unit;
split the feature map into an on-chip unit map if the storage space required by the feature map is greater than the available space of the shared storage unit, where storage space required by the on-chip unit map is not greater than the available space of the shared storage unit; and
determine the template fuse unit according to a size of the on-chip unit map.

Article C2. The integrated circuit apparatus of article C1, where the feature map includes N, H, W, and C dimensions, and the processing apparatus performs splitting in the N dimension with specific granularity.

Article C3. The integrated circuit apparatus of article C1, where the feature map includes N, H, W, and C dimensions, and the processing apparatus performs splitting in one of the H and W dimensions with specific granularity.

Article C4. The integrated circuit apparatus of article C1, where the feature map includes N, H, W, and C dimensions, and the processing apparatus performs splitting in the C dimension with specific granularity.

Article C5. The integrated circuit apparatus of article C1, where the feature map includes N, H, W, and C dimensions, and the processing apparatus performs splitting between the N, H and W dimensions in order with specific granularity.

Article C6. The integrated circuit apparatus of article C1, where the feature map includes a plurality of dimensions, the processing apparatus performs splitting in one of the plurality of dimensions with specific granularity until the dimension is unable to be split, and then the processing apparatus chooses to perform splitting in another dimension in the plurality of dimensions.

Article C7. The integrated circuit apparatus of any one of articles C1-C6, where the processing apparatus is further configured to:

judge whether storage space required by the split feature map is greater than the available space of the shared storage unit; and set the split feature map as the on-chip unit map if the storage space required by the split feature map is not greater than the available space of the shared storage unit.

Article C8. A board card, including the integrated circuit apparatus of any one of articles C1-C7.

Article C9. A method for fusing each layer of a neural network into a template fuse unit according to a feature map, including:

judging whether storage space required by the feature map is greater than available space of a shared storage unit in a cluster;

splitting the feature map into an on-chip unit map if the storage space required by the feature map is greater than the available space of the shared storage unit in the cluster, where storage space required by the on-chip unit map is not greater than the available space of the shared storage unit; and

determining the template fuse unit according to a size of the on-chip unit map.

Article C10. The method of article C9, where the feature map includes N, H, W, and C dimensions, and a step of splitting is performed in the N dimension with specific granularity.

Article C11. The method of article C9, where the feature map includes N, H, W, and C dimensions, and a step of splitting is performed in one of the H and W dimensions with specific granularity.

Article C12. The method of article C9, the feature map includes N, H, W, and C dimensions, and a step of splitting is performed in the C dimension with specific granularity.

Article C13. The method of article C9, where the feature map includes N, H, W, and C dimensions, and a step of splitting is performed between the N, H, and W dimensions in order with specific granularity.

Article C14. The method of article C9, where the feature map includes a plurality of dimensions, a step of splitting is performed in one of the plurality of dimensions with specific granularity until the dimension is unable to be split, and then another dimension in the plurality of dimensions is selected for splitting.

Article C15. The method of any one of articles C9-C14, further including:

judging whether storage space required by the split feature map is greater than the available space of the shared storage unit; and setting the split feature map as the on-chip unit map if the storage space required by the split feature map is not greater than the available space of the shared storage unit.

Article C16. A computer readable storage medium, on which computer program codes for fusing each layer of a neural network into a template fuse unit according to a feature map are stored, where, when the computer program codes are run by a processing apparatus, the method of any one of articles C9-C15 is performed. 2020110439059

2020110458581 Article D1. An integrated circuit apparatus for fusing each layer of a neural network into a template fuse unit according to a plurality of feature maps, including:

a computing apparatus, which includes a plurality of clusters, where each cluster includes a shared storage unit configured to store an on-chip unit map; and

a processing apparatus configured to:

judge whether storage space required by one of the plurality of feature maps is greater than available space of the shared storage unit, where

the on-chip unit map includes the one of the plurality of feature maps if the storage space required by one of the plurality of feature maps is not greater than the available space of the shared storage unit; and

determine the template fuse unit according to a size of the on-chip unit map.

Article D2. The integrated circuit apparatus of article D1, where the processing apparatus continues to judge whether total storage space required by other feature maps and the one of the plurality of feature maps is greater than the available space of the shared storage unit, and the on-chip unit map further includes other feature maps if the total storage space required by other feature maps and the one of the plurality of feature maps is greater than the available space of the shared storage unit.

Article D3. The integrated circuit apparatus of article D2, where the shared storage unit includes cache space with the same size as the on-chip unit map.

Article D4. The integrated circuit apparatus of article D2, where the processing apparatus judges whether the number of feature maps in the on-chip unit map is not greater than a feature map threshold, and if the number of feature maps in the on-chip unit map is greater than the feature map threshold, the processing apparatus reduces the number of feature maps in the on-chip unit map until the number of feature maps in the on-chip unit map is not greater than the feature map threshold.

Article D5. The integrated circuit apparatus of article D2, where the cluster includes a plurality of processor cores, and the computing apparatus divides the on-chip unit map into sub-maps and loads one sub-map to one corresponding processor core of the plurality of processor cores for computing from the shared storage unit every time.

Article D6. The integrated circuit apparatus of article D1, where the processing apparatus judges that the storage space required by the one of the plurality of feature maps is greater than the available space of the shared storage unit, and then the one of the plurality of feature maps is split into the on-chip unit map.

Article D7. A board card, including the integrated circuit apparatus of any one of articles D1-D6.

Article D8. A method for fusing each layer of a neural network into a template fuse unit according to a plurality of feature maps in an integrated circuit apparatus, where the integrated circuit apparatus includes a computing apparatus, which includes a plurality of clusters, each cluster includes a shared storage unit, which is configured to store an on-chip unit map, and the method includes:

judging whether storage space required by one of the plurality of feature maps is greater than available space of the shared storage unit, where

the on-chip unit map includes the one of the plurality of feature maps if the storage space required by one of the plurality of feature maps is not greater than the available space of the shared storage unit; and determining the template fuse unit according to a size of the on-chip unit map.

Article D9. The method of article D8, further including:

judging whether total storage space required by other feature maps and the one of the plurality of feature maps is greater than the available space of the shared storage unit; and

containing other feature maps into the on-chip unit map if the total storage space required by other feature maps and the one of the plurality of feature maps is not greater than the available space of the shared storage unit.

Article D10. The method of article D9, further including:

setting cache space with the same size as the on-chip unit map in the shared storage unit.

Article D11. The method of article D9, further including:

judging whether the number of feature maps in the on-chip unit map is not greater than a feature map threshold; and

reducing the number of feature maps in the on-chip unit map until the number of feature maps in the on-chip unit map is not greater than the feature map threshold if the number of feature maps in the on-chip unit map is greater than the feature map threshold.

Article D12. The method of article D9, where the cluster includes a plurality of processor cores, and the method further includes:

dividing the on-chip unit map into sub-maps; and

loading one sub-map to one of the plurality of processor cores for computing from the shared storage unit every time.

Article D13. The method of article D8, where, when the storage space required by the one of the plurality of feature maps is greater than the available space of the shared storage unit, the one of the plurality of feature maps is split into the on-chip unit map.

Article D14. A computer readable storage medium, on which computer program codes for fusing each layer of a neural network into a template fuse unit according to a plurality of feature maps are stored, where, when the computer program codes are run by a processing apparatus, the method of any one of articles D8-D13 is performed. 2020110458581

2020110438978 Article E1. An integrated circuit apparatus for dynamically fusing a neural network according to a fusion policy, including:

a computing apparatus, which includes a plurality of clusters, where each cluster includes a shared storage unit, which is configured to store an on-chip unit map; and

a processing apparatus configured to:

judge whether storage space required by at least one feature map is greater than available space of the shared storage unit; and

set the at least one feature map as the on-chip unit map and check a rule related with the shared storage unit in the fusion policy to create the template fuse unit if the storage space required by the at least one feature map is not greater than the available space of the shared storage unit.

Article E2. The integrated circuit apparatus of article E1, where the fusion policy is that, if storage space of the on-chip unit map and storage space of a computing result of the on-chip unit map are unable to be reused, a sum of the storage space of the on-chip unit map and the storage space of the computing result of the on-chip unit map is less than the available space of the shared storage unit.

Article E3. The integrated circuit apparatus of article E1, where the fusion policy is that, if storage space of the on-chip unit map and storage space of a computing result of the on-chip unit map are able to be reused, the larger of the storage space of the on-chip unit map and the storage space of the computing result of the on-chip unit map is less than the available space of the shared storage unit.

Article E4. The integrated circuit apparatus of article E1, where the cluster further includes a plurality of processor cores and a memory core; the memory core splits the on-chip unit map into a sub-map; one of the processor cores computes the sub-map; and the shared storage unit includes cache space with the same size as the on-chip unit map.

Article E5. The integrated circuit apparatus of article E4, where a rule is that a sum of storage space required by a weight of the sub-map, storage space required by the on-chip unit map, and the cache space is not greater than the available space of the shared storage unit.

Article E6. The integrated circuit apparatus of article E4, where a rule is that a sum of storage space required by the sub-map, storage space required by a weight of the sub-map, and the cache space is not greater than the available space of the shared storage unit.

Article E7. The integrated circuit apparatus of article E4, where the processor core includes an operation unit, which is configured to compute the sub-map to generate an intermediate result, and a rule is that a sum of storage space required by the intermediate result, storage space required by a weight of a next sub-map, and the cache space is not greater than the available space of the shared storage unit.

Article E8. The integrated circuit apparatus of any one of articles E1-E7, where, when the processing apparatus judges that the rule is not satisfied, the processing apparatus reduces the number of feature maps in the on-chip unit maps until the rule is satisfied.

Article E9. A board card, including the integrated circuit apparatus of any one of articles E1-E8.

Article E10. A method for dynamically fusing a neural network according to a fusion policy in an integrated circuit apparatus, where the integrated circuit apparatus includes a computing apparatus, which includes a plurality of clusters, each cluster includes a shared storage unit, which is configured to store an on-chip unit map, and the method includes:

judging whether storage space required by at least one feature map is greater than available space of the shared storage unit; and

if the storage space required by the at least one feature map is not greater than the available space of the shared storage unit,

setting the at least one feature map as the on-chip unit map; and

checking a rule related with the shared storage unit in the fusion policy to create the template fuse unit.

Article E11. The method of article E10, further including:

judging whether the on-chip unit map and a computing result of the on-chip unit map are able to be reused; and

setting a rule that a sum of storage space of the on-chip unit map and storage space of the computing result of the on-chip unit map is less than the available space of the shared storage unit if the on-chip unit map and the computing result of the on-chip unit map are unable to be reused.

Article E12. The method of article E10, further including:

judging whether the on-chip unit map and a computing result of the on-chip unit map are able to be reused; and

setting a rule that the larger of storage space of the on-chip unit map and storage space of the computing result of the on-chip unit map is less than the available space of the shared storage unit if the on-chip unit map and the computing result of the on-chip unit map are able to be reused.

Article E13. The method of article E10, where the cluster further includes a plurality of processor cores and a memory core; the memory core splits the on-chip unit map into a sub-map; one of the processor cores computes the sub-map, and the shared storage unit includes cache space with the same size as the on-chip unit map.

Article E14. The method of article E13, where a rule is that a sum of storage space required by a weight of the sub-map, storage space required by the on-chip unit map, and the cache space is not greater than the available space of the shared storage unit.

Article E15. The method of article E13, where a rule is that a sum of storage space required by the sub-map, storage space required by a weight of the sub-map, and the cache space is not greater than the available space of the shared storage unit.

Article E16. The method of article E13, where the processor core includes an operation unit, which is configured to compute the sub-map to generate an intermediate result, and a rule is that a sum of storage space required by the intermediate result, storage space required by a weight of a next sub-map, and the cache space is not greater than the available space of the shared storage unit.

Article E17. The method of any one of articles E10-E16, where, when the rule is found not to be satisfied in a step of checking, the method further includes:

reducing the number of feature maps in the on-chip unit map until the rule is satisfied.

Article E18. A computer readable storage medium, on which computer program codes for dynamically fusing a neural network according to a fusion policy are stored, where, when the computer program codes are run by a processing apparatus, the method of any one of articles E10-E17 is performed. 2020110438978

The embodiments of the present disclosure have been described in detail above. The present disclosure uses specific examples to explain principles and implementations of the present disclosure. The descriptions of the embodiments above are only used to facilitate understanding of the method and core ideas of the present disclosure. Simultaneously, those skilled in the art may change the specific implementations and application scope of the present disclosure based on the ideas of the present disclosure. In summary, the content of this specification should not be construed as a limitation on the present disclosure.

What is claimed:

1. An integrated circuit apparatus for forward fusing a neural network, comprising:
a processing apparatus configured to perform a fusion in a direction of a starting point of the neural network to create a template fuse unit; and
a computing apparatus configured to perform neural network computing according to the template fuse unit.

2. The integrated circuit apparatus of claim 1, wherein the processing apparatus selects a starting layer of the fusion according to a fusion policy, wherein
the processing apparatus performs the fusion in the direction of the starting point of the neural network from the starting layer.

3. The integrated circuit apparatus of claim 2, wherein a top layer of the template fuse unit is an input layer of the template fuse unit, the starting layer is an output layer of the template fuse unit, and the processing apparatus performs a pyramid fusion based on the input layer and the output layer.

4. The integrated circuit apparatus of claim 2, wherein layers in the template fuse unit are continuous.

5. The integrated circuit apparatus of claim 4, wherein, when performing the fusion in the direction of the starting point of the neural network, the processing apparatus judges whether a newly added layer has already been fused, and if the newly added layer has already been fused, the processing apparatus stops the fusion.

6. The integrated circuit apparatus of claim 4, wherein, when performing the fusion in the direction of the starting point of the neural network, the processing apparatus judges whether a newly added layer has already been fused, and if the newly added layer has already been fused, the processing apparatus performs a fusion in a direction of an ending point of the neural network.

7. The integrated circuit apparatus of claim 4, wherein, after the processing apparatus performs the fusion in the direction of the starting point of the neural network, the processing apparatus continues to perform a fusion in a direction of an ending point of the neural network to perform a jump fusion.

8. The integrated circuit apparatus of claim 7, wherein a top layer of continuous layers is an input layer of the template fuse unit, and a last layer of a backward jump is an output layer of the template fuse unit.

9. The integrated circuit apparatus of claim 3, wherein the output layer is a single-branch output.

10. The integrated circuit apparatus of claim 7, wherein the jump fusion is performed once as n layers are fused every time, wherein n is a natural number.

11. The integrated circuit apparatus of claim 2, wherein the starting layer is a top unfused convolution or pooling layer.

12. The integrated circuit apparatus of claim 1, wherein, when the neural network is a block structure, the processing apparatus performs the fusion by taking the block structure as a unit.

13. The integrated circuit apparatus of claim 1, wherein the neural network comprises a plurality of main layers, wherein a main layer is one of matrix multiplication, pooling, and convolution, and the template fuse unit comprises at least two main layers.

14. The integrated circuit apparatus of claim 13, wherein the template fuse unit comprises a continuous structure in which the main layer, the main layer, and a non-main layer are successively adjacent.

15. The integrated circuit apparatus of claim 14, wherein the structure is a single branch.

16. The integrated circuit apparatus of claim 1, wherein the template fuse unit comprises a continuous structure in which a scalar computing layer and a vector computing layer are adjacent, wherein
the scalar computing layer comprises one of an addition layer, a subtraction layer, and a multiplication layer, and the vector computing layer comprises one of an activation layer, a batch normalization layer, and a scaling layer.

17. A board card, comprising an integrated circuit apparatus that includes:
a processing apparatus configured to perform a fusion in a direction of a starting point of the neural network to create a template fuse unit; and
a computing apparatus configured to perform neural network computing according to the template fuse unit.

18-20. (canceled)

21. The board card of claim 17, wherein the processing apparatus selects a starting layer of the fusion according to a fusion policy, wherein the processing apparatus performs the fusion in the direction of the starting point of the neural network from the starting layer.

22. The board card of claim 21, wherein a top layer of the template fuse unit is an input layer of the template fuse unit, the starting layer is an output layer of the template fuse unit, and the processing apparatus performs a pyramid fusion based on the input layer and the output layer.

23. The board card of claim 21, wherein layers in the template fuse unit are continuous.
